(19) United States
(12) Patent Application Publication
(10) Pub. No.: US 2020/0274363 A1
(43) Pub. Date: Aug. 27, 2020

(54) STORAGE-BATTERIES SUPERVISORY CONTROL SYSTEM, CHARGE/DISCHARGE CONTROL SYSTEM, CONTROL DEVICE, AND TERMINAL DEVICE

(71) Applicant: NEC CORPORATION, Tokyo (JP)

(72) Inventor: Koji KUDO, Tokyo (JP)

(73) Assignee: NEC CORPORATION, Tokyo (JP)

(21) Appl. No.: 16/788,561

(22) Filed: Feb. 12, 2020

(30) Foreign Application Priority Data
Feb. 25, 2019 (JP) 2019-032048

(51) Int. Cl. H02J 3/32; H02J 13/00; G06Q 50/06; H02J 3/00; H02J 7/00

(52) U.S. Cl. CPC H02J 3/32; H02J 13/00002; H02J 7/0013; H02J 3/003; G06Q 50/06

(57) ABSTRACT

A power storage system is configured to carry out a plurality of services having different responses in a concurrent-multiuse manner with a storage battery under control of a control device. The control device is configured to calculate a value of charge/discharge power for each service and to thereby produce a summation of charge/discharge power for the plurality of services according to an upper-limit value of charge/discharge power for each service which is set by a host device. The control device is further configured to control the storage battery to charge or discharge power according to the summation of charge/discharge power.

### CROSS-REFERENCE TO RELATED APPLICATION

The present application claims the priority benefit of Japanese Patent Application No. 2019-32048 filed on Feb. 25, 2019, the subject matter of which is hereby incorporated herein by reference.

### BACKGROUND OF THE INVENTION

### 1. Field of the Invention

The present invention relates to a storage-batteries supervisory control system, a charge/discharge control system, a control device, and a terminal device.

### 2. Description of Related Art

As services using charging and discharging of power storage systems at consumers, it is possible to carry out multiple services for leveling tidal currents over power-interconnect lines depending on time zones and statuses such as power leveling in renewable energy generation, peak shifting, and peak cutting. Multiple services devoted to a single power storage system may attempt to realize a multiuse power storage system implementing a method of expanding applicable services in power storage systems. In particular, it is possible to realize multiuse time-zone services for each time zone by carrying out different services for different time zones. However, multiuse time-zone services may not necessarily improve a ratio of an actual output to the rated output of a power storage system and usage efficiency of storage-battery capacities.

To improve usage efficiency of a power storage system, it is effective to carry out concurrent multiuse services, i.e. multiuse services for concurrently carrying out difference services in a same time zone. For example, Patent Document discloses a multipurpose control device of a power battery system configured to concurrently carry out multiple services (e.g. peak shifting and power-variation suppression) for leveling tidal currents over power-interconnect lines.

### 3. Patent Document

Japanese Patent Application Publication No. 2014-236600

### 4. Technical Problem

The concurrent multiuse services disclosed in Patent Document may involve services for leveling tidal currents over power-interconnect lines, which may affect the status of local feeder lines. To improve added values, it is preferable to concurrently carry out power-adjustment services for maintaining demand-supply balances in the entirety of systems in addition to power-leveling services for leveling tidal currents over power-interconnect lines.

Among those services, power-leveling services for leveling tidal currents over power-interconnect lines can be achieved by a single power storage system. In contrast, a single power storage system is insufficient to achieve power-adjustment services, which need charging and discharging to achieve a desired amount of adjusted power in the entirety of multiple power storage systems which should be synchronized to cooperate with each other.

A plurality of power storage systems may include various types of power storage systems and/or power storage systems having various functions. A power storage system is configured to carry out multiple services, including one service which may allow for a delay over one second and another service which may require a quick response below one second; hence, each service may require a different response. For this reason, concurrent multiuse services, which are configured to concurrently carry out power-adjustment services in addition to power-leveling services for leveling tidal currents over power-interconnect lines, need to carry out a plurality of services having different responses by way of cooperation of various types of power storage systems.

The present invention aims to provide a storage-batteries supervisory control system, a charge/discharge control system, a control device, and a terminal device, which can solve the above problem. In particular, the present invention aims to provide a control device, a terminal device, and a control method for controlling a storage battery with respect to a plurality of services in a concurrent-multiuse manner.

### SUMMARY OF THE INVENTION

In a first aspect of the present invention, a control device is configured to control a power storage system including a storage battery in connection with a host device configured to set an upper-limit value of charge/discharge power for each service among a plurality of services. The control device includes a summation calculation part configured to calculate a value of charge/discharge power for each service so as to produce a summation of charge/discharge power for a plurality of services according to the upper-limit value of charge/discharge power for each service, and a charge/discharge control part configured to control the storage battery to charge or discharge power according to the summation of charge/discharge power.

In a second aspect of the present invention, a terminal device is configured to control a power storage system including a storage battery in connection with a host device configured to set an upper-limit value of charge/discharge power for each service among a plurality of services. The terminal device includes a summation calculation part configured to calculate a value of charge/discharge power for each service so as to produce a summation of charge/discharge power for a plurality of services according to the upper-limit value of charge/discharge power for each service, and a charge/discharge control part configured to control the storage battery to charge or discharge power according to the summation of charge/discharge power.

In a third aspect of the present invention, a control method for controlling a storage battery with respect to a plurality of services includes the steps of: calculating a value of charge/discharge power for each service among a plurality of services; calculating a summation of charge/discharge power for a plurality of services according to an upper-limit value of charge/discharge power for each service; and controlling the storage battery to charge or discharge power according to the summation of charge/discharge power.

According to the present invention, it is possible for a power storage system to carry out a plurality of services having different responses in a concurrent-multiuse manner in cooperation with other power storage systems.

### BRIEF DESCRIPTION OF THE DRAWINGS

FIG. 1 is a block diagram showing a configuration example of a power system including a storage-batteries supervisory control system according to the preferred embodiment of the present invention.

FIG. 2 is a schematic diagram showing an example of a service provided by a resource aggregator using the power system of FIG. 1.

FIG. 3 shows an example of services provided by the power system of FIG. 1.

FIG. 4 is a block diagram showing a layout example of sensors used for a consumer-installed system shown in FIG. 1 to carry out services.

FIG. 5 is a block diagram showing an example of input/output data for the consumer-installed system to carry out services.

FIG. 6 is a block diagram showing an example of a functional configuration of a power conditioning system applied to a storage battery in a power storage system shown in FIG. 1.

FIG. 7 is a block diagram showing another example of a functional configuration of a power conditioning system.

FIG. 8 is a block diagram showing a further example of a functional configuration of a power conditioning system.

FIG. 9 is a line graph showing an example of a usage ratio of an output of a power storage system, which is included in the consumer-installed system shown in FIG. 1, allocated to services.

FIG. 10 is a bar graph showing an example of totaling usage ratios of the output of the power storage system allocated to services.

FIG. 11 a graph showing an example of transition of controlling the output of the power storage system allocated to services.

FIG. 12 is a flowchart showing an example of a process to calculate cumulative values of electric energy by an energy cumulation part.

FIG. 13 is a sequence diagram showing an example of a process to carry out services by the power system.

FIG. 14 is a sequence diagram showing a first example of a process to calculate a value of charge/discharge power and to control the storage battery.

FIG. 15 is a sequence diagram showing a second example of a process to calculate a value of charge/discharge power and to control the storage battery.

FIG. 16 is a block diagram showing a configuration example of a control device according to another embodiment of the present invention.

FIG. 17 is a flowchart showing an example of a process to implement a control method according to another embodiment of the present invention.

FIG. 18 is a block diagram showing a configuration example of a computer applicable to any devices configuring the storage-batteries supervisory control system according to any embodiments of the present invention.

### DETAILED DESCRIPTION OF THE EMBODIMENTS

The present invention will be described by way of examples and embodiments with reference to the drawings, wherein the parts identical to those shown in various drawings are denoted by the same reference signs; hence, descriptions thereof will be omitted here.

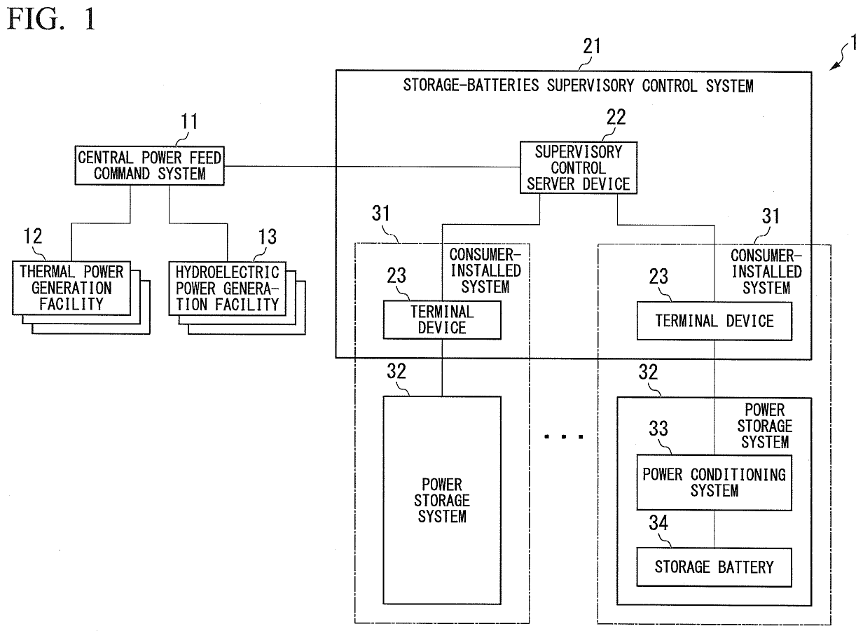

FIG. 1 shows a power system 1 according to the preferred embodiment of the present invention. The power system 1 includes a central power feed command station 11, a thermal power generation facility 12, a hydroelectric power generation facility 13, a supervisory control server device 22, a terminal device 23, and a power storage system 32. The power storage system 32 further includes a power conditioning system (PCS) 33 and a storage battery 34.

A combination of the terminal device 23 and the power storage system 32 will be referred to as a consumer-installed system 31. A combination of the supervisory control server device 22 and the terminal device 23 will be referred to as a storage-batteries supervisory control system 21. Alternatively, the storage-batteries supervisory control system 21 may further include the power conditioning system 33 in addition to the supervisory control server device 22 and the terminal device 23, or the supervisory control system 21 may further include the storage battery 34.

The central power feed command station 11 is configured to instruct the thermal power generation facility 12 and the hydroelectric power generation facility 13 to output power while instructing charge-discharge power with the supervisory control server device 22, thus adjusting power applied to the power system.

The thermal power generation facility 12 and the hydroelectric power generation facility 13 are configured to output power according to power-generation instructions issued by the central power feed command system 11.

In this connection, the central power feed command station 11 issues power-output instructions to various types of power generation facilities and the arbitrary number of power generation facilities, which are not necessarily limited to the specific type of power generation facilities and the fixed number of power generation facilities. For example, the central power feed command station 11 may issue power-output instructions to one or both of biomass power generation facilities and geothermal power generation facilities in addition to or instead of the thermal power generation facility 12 and the hydroelectric power generation facility 13.

For example, power transmission/distribution business operators may possess the central power feed command station 11 and power generation facilities (e.g. the thermal power generation facility 12 and the hydroelectric power generation facility 13 shown in FIG. 1) configured to receive power-output instructions issued by the central power feed command system 11.

The supervisory control server device 22 is configured to provide the information to realize concurrent multiuse services at the consumer-installed system 31. The consumer-installed system 31 carries out concurrent multiuse services to concurrently achieve multiple services. Herein, the term “services” may be dedicated to accomplish a certain purpose by charging or discharging storage batteries.

In particular, the supervisory control server device 22 is configured to set an upper-limit value of charging and discharging power for each of consumer-installed systems 31 and for each of services made by each consumer-installed system 31. A host device may exemplify the supervisory control server device 22.

The supervisory control server device 22 is configured to calculate the upper-limit value using at least one of the system status information and the status information of the power storage system 32, which will be discussed later. Herein, the term “system” may represent a power system owned by a power transmission/distribution business operator. The storage battery 34 and the load on the consumer side are connected to the system through a pole transformer, which will be discussed later.

The supervisory control server device 22 may instruct a value of charge/discharge power instead of the upper-limit value with respect to a part of services made by the consumer-installed system 31, for example, in which the consumer-installed system 31 may transmit an LFC signal (where LFC stands for “Load Frequency Control”). For example, the supervisory control server device 22 is configured of a computer such as an engineering workstation (EWS). The supervisory control server device 22 may be possessed by a resource aggregator (RA), i.e. an operator who provide services by integrating consumer-side power facilities.

The power conditioning system 33 is configured to control charging or discharging power with the storage battery 34. In particular, the power conditioning system 33 adds up values of charge/discharge power, which can be calculated by the power conditioning system 33 or the terminal device 23, according to the upper-limit value of charging or discharging power for each service which is set by the supervisory control server device 22 (or by heeding restrictions of upper-limit values), thus controlling the storage battery 34 to charge or discharge power according to the summation of charge/discharge power. The power conditioning system 33 may exemplify a control device configured to control charge/discharge power with a storage battery.

The power conditioning system 33 is further configured to make a conversion between alternate-current (AC) power of the system and direct-current (DC) power to be charged or discharged with the storage battery 34, i.e. “AC-to-DC conversion” and “DC-to-AC conversion”. In particular, it is possible to use a charging/discharging operation of the power storage system 32 for the purpose of controlling the system frequency (e.g. Δf control) using deviations (i.e. a difference from a reference frequency, e.g. 50 Hz or 60 Hz) from the AC frequency of the system to be measured by the power conditioning system 33.

In the above, both the LFC and the Δf control are used to adjust the system frequency to the reference frequency. For example, the LFC is used to charge or discharge power in a period of several seconds while the Δf control is used to charge or discharge power in a shorter period less than one second. That is, the LFC has a relatively longer period and a relatively lower response than the Δf control.

The Δf control will be referred to as a governor-free operation in a power generator, whereas a power storage system having no governor may be equivalent to governor-free control and will be therefore referred to as governor-free equivalent control.

For example, the power conditioning system 33 is configured of a computer such as an engineering workstation (EGW) and a microcomputer.

The storage battery 34 may charge or discharge power under the control of the power conditioning system 33. The terminal device 23 is configured to calculate values of charge/discharge power with respect to part of services. For example, the terminal device 23 may calculate an amount of charge/discharge power in a service like the LFC having a relatively low response.

It is possible to reduce the load of the power conditioning system 33 to calculate an amount of charge/discharge power since the terminal device 23 may calculate an amount of charge/discharge power in part of services, and therefore it is possible to secure an adequate response of the consumer-installed system 31. In particular, the terminal device 23 is configured to calculate an amount of charge/discharge power in a service like the LFC not requiring a quick response, and therefore it is possible to secure a desired response for each concurrent multiuse service with the consumer-installed system 31 as a whole.

In addition, the terminal device 23 may share part of functionality such as one or both of the LFC to calculate an amount of charge/discharge power and the Δf control to calculate an amount of charge/discharge power, and therefore it is possible to connect the terminal device 23 to the existing power storage system and to thereby achieve one or both of the FLC and the Δf control. In short, it is possible to effectively utilize the existing power storage system using the terminal device 23.

All the terminal device 23, the power conditioning system 33, and the storage battery 34 are installed on the consumer side. However, the terminal device 23 may be owned by a resource aggregator or a consumer. Alternatively, a resource aggregator may lend the terminal device 23 to a consumer. In this connection, both the power conditioning system 33 and the storage battery 34 will be owned by a consumer.

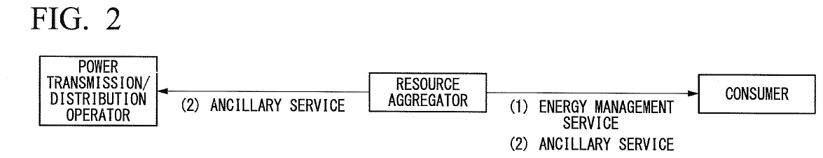

FIG. 2 shows an example of services which a resource aggregator provides using the power system 1.

In FIG. 2, a resource aggregator provides energy management services, an example of which may be peak shifting: but this is not a restriction.

The peak shifting is an example of services to reduce an electricity rate in such a way that a storage battery is charged in a time zone claiming a relatively low electricity rate while a storage capacity supplies device-consuming power in another time zone claiming a relatively high electricity rate (by discharging its power).

The peak cutting is an example of services to cut a peak demand of power by discharging power with a storage battery when power consumption becomes greater than threshold power which is set in advance. When electricity rates are determined in a stepwise manner according to the maximum power supply, for example, it is possible to reduce electricity rates by decreasing maximum power via peak cutting.

In addition, a resource aggregator may provide ancillary services (or power-adjustment services) to power transmission/distribution business operators, wherein ancillary services are used to maintain an adequate quality of power. As examples of ancillary services which a resource aggregator can provide to a power transmission/distribution business operator, it is possible to mention the LFC, the Δf control, and the demand response; but this is not a restriction. For example, the demand response can be defined as an operation to change power-consumption patterns such that consumers can suppress their power use according to settings of electricity rates and incentive payments to cope with soaring prices in wholesale power transaction markets or a reduction of system reliability. In this connection, ancillary services may be referred to as system-oriented services.

A resource aggregator may provide ancillary services using the power storage system 32 owned by a consumer, thus allowing a consumer to get incentive payments. In FIG. 2, ancillary services are defined as services provided to consumers by a resource.

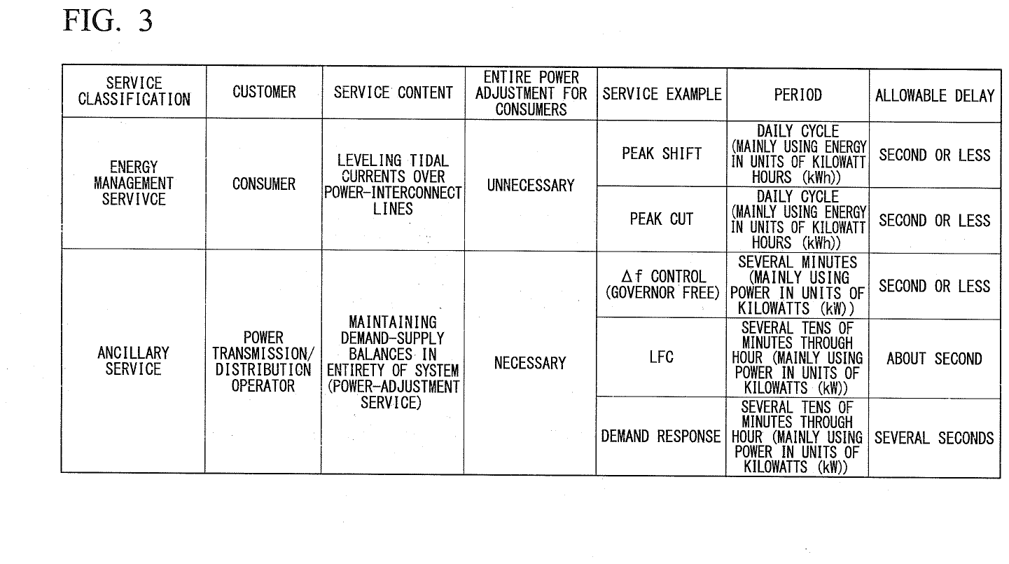

FIG. 3 shows examples of services provided by the power system 1. In FIG. 3, the power system 1 provides various services, which can be classified into energy management services and ancillary services. Energy management services are consumer-oriented services directed to consumers serving as customers such as power-leveling services for leveling tidal currents over power-interconnect lines. Power-leveling services for leveling tidal currents over power-interconnect lines are carried out by users adjusting power-use patterns of the system power, in which consumers may concentrate system-power consumption (i.e. consumption of commercial power provided by an electricity company) in time zones having relatively low electricity rates or in which consumers may reduce the maximum power of system-power consumption to a relatively small amount of electricity. Energy management services would be carried out by individual consumers alone; hence, it is unnecessary to adjust power in the entirety of consumers.

As examples of energy management services, it is possible to mention peak shifting and peak cutting. Both the peak shifting and the peak cutting may have a relatively long cycle (e.g. a daily cycle) as a period of charging or discharging power. In this connection, both the peak shifting and the peak cutting may be regarded as services mainly using energy in units of kilowatt hours (kWh). For example, charging and discharging energy in units of kilowatt hours (kWh) can be regarded as long-period charging and discharging recognizable in variations of charging rates with storage batteries. However, both the peak shifting and peak cutting require a quick response to load variations (although the peak cutting for industrial use may allow for measurement units of thirty minutes), wherein it allows for a delay below one second. As a charging rate of a storage battery, for example, it is possible to use the state of charge (SOC).

Ancillary services are customer-services oriented to power transmission/distribution business operators to maintain an adequate power quality by maintaining one or both of the system voltage and the frequency at constant values, for example, by maintaining demand-supply balances in the entire system. Ancillary services should cover the entire system, and therefore it is necessary to adjust the system voltage or the frequency with respect to the entirety of consumers connected to the system.

As examples of ancillary services, it is possible to mention the Δf control, the demand response, and the LFC. Among them, the Δf control has a relatively short period to change the charging side and the discharging side, e.g. a period of several minutes. In this connection, the Δf control may be regarded as services using power in units of kilowatts (kW). The charging and discharging power in units of kilowatts (kW) may indicate a short period of changing the charging side and the discharging side in an unrecognizable manner of charging rates with storage batteries. However, the Δf control requires a quick response by a high-speed operation, which may allow for a delay below one second. This is because irrespective of the charging control at the charging side, the Δf may undergo rapid variations of charging amplitudes in a short period less than seconds. The same can be said of the discharging side.

Among ancillary services, both the LFC and the demand response may have a period of changing the charging side and the discharging side in several tens of minute through an hour or so, which is a relatively long period compared to the Δf control having a period of several minutes but which is a relatively short period compared to the peak shifting and the peak cutting. The period of several tens of minutes may be regarded as a relatively short period in consideration of the charging rate (SOC) of a storage battery, and therefore both the LFC and the demand response may be regarded as services mainly using power in units of kilowatts (kW). Herein, the LFC may allow for a delay of one second while the demand response may allow for a delay of several seconds. That is, the LFC and the demand response may allow for a delay time relatively longer than the peak shifting, the peak cutting, and the Δf control.

As shown in FIG. 1, the consumer-installed system 31 is equipped with the terminal device 23 configured to calculate an amount of charge/discharge power in services not requiring a quick response (e.g. the LFC or the demand response allowing for a relatively long delay time), and therefore it is possible to reduce the load to calculate an amount of charge/discharge power; hence, it is possible to secure an adequate response in the entirety of the consumer-installed system 31.

As an operating body for substantially calculating an amount of charge/discharge power, the supervisory control server device 22 may calculate and transmit the charge/discharge power to the consumer-installed system 31 in services not requiring a quick response (e.g. the LFC or the demand response). In the LFC, for example, the supervisory control server device 22 may calculate the charge/discharge power in consideration of the upper-limit value so as to transmit an LFC signal representing the charge/discharge power to the terminal device 23. Alternatively, in the LFC, the supervisory control server device 22 may substantially calculate the charge/discharge power so as to transmit a LFC signal representing a ratio of the charge/discharge power to the upper-limit value to the terminal device 23. In this case, the terminal device 23 may finally calculate the charge/discharge power corresponding to the LFC signal. In services requiring a quick response such as the Δf control, the power conditioning system 33 may calculate the charge/discharge power in order to prevent a delay due to a communication time.

Hereinafter, the information representing the upper-limit value of the charge/discharge power such as the upper-limit value of power for power-leveling services for leveling tidal currents in power-interconnect lines and the upper-limit value of power for power-adjustment services will be referred to as the information for concurrent multiuse services. The upper-limit value of power for power-leveling services for leveling tidal currents in power-interconnect lines indicates the upper-limit value of charge/discharge power in consumer-oriented services such as the peak shifting, the peak cutting, and the power-variation control. The upper-limit value of power for power-adjustment services indicates the upper-limit value of charge/discharge power in ancillary services such as the LFC, the demand response, and the Δf control (e.g. the information of the upper-limit power included in the Δf control-sharing function).

The information representing the system status such as LFC signals (i.e. signals calculated by the central power feed command system 1 based on the system status such as the total demand of power P in a power system, a system constant K, a frequency deviation Δf, and a tidal-current deviation ΔPt over power-interconnect lines), a frequency deviation (Δf), a power load, a voltage and a phase of power-interconnect lines will be referred to as the system status information. In addition, the information relating to the entirety of consumers such as control values of charge/discharge power over the entirety of consumers in the Δf control will be referred to as the group cooperation information over the entirety of consumers. It is possible to calculate an amount of charge/discharge power using the concurrent multiuse information (i.e. the information representing concurrent multiuse services), the system status information, and the group cooperation information.

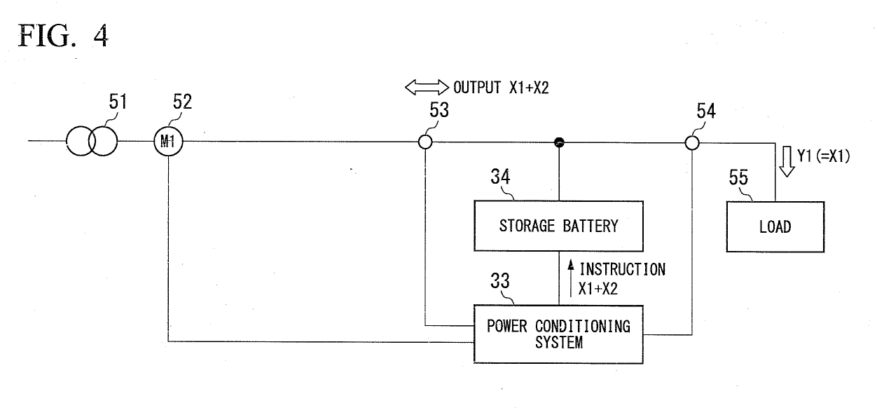

FIG. 4 shows a layout example of sensors used for services to be carried out by the consumer-installed system 31. In FIG. 4, the storage battery 34 and a load 55 at a consumer are connected to a power system of a power transmission/distribution business operator via a pole transformer 51. Viewing from the pole transformer 51, a smart meter (M1) 52, a first sensor 53, and a second sensor 54 are connected to the storage battery 34.

FIG. 4 shows X1 representing a contribution of a peak-shifting service to the load 55, X2 representing an output of an ancillary service, and Y1 representing power consumption (or load power) of the load 55. In the day time, i.e. a time zone claiming a high electricity rate, it is possible to assume that the storage battery 34 is ready to discharge load-following power in a peak-shifting service. In this case, the storage battery 34 provides OUTPUT×1 to substantially suffice the power consumption of the load 55; hence, it is possible to express “Y1≅X1”. In this connection, the storage battery 34 outputs the charge/discharge power by charging or discharging power (e.g. output power of the storage battery 34).

The smart meter 52 is provided to charge fees for electric power used by a consumer. The first sensor 53 is disposed at a position to measure the total output of the storage battery 34. The total output of the storage battery 34 is a combination of a peak-shift output (X1) and an ancillary-service output (X2), which is expressed as X1+X2. As shown in FIG. 4, the power conditioning system 33 instructs the storage battery 34 to output the charge/discharge power of X1+X2, and therefore the storage battery 34 will output the charge/discharge power according to an instruction of the power conditioning system 33, in other words, the storage battery 34 will charge or discharge power. The second sensor 54 is disposed at a position to measure the power consumption of the load 55 (i.e. load power Y1).

To calculate the charge/discharge power for consumers (for the purpose of energy management), the power conditioning system 33 calculates the peak-shift charge/discharge power (OUTPUT×1) with reference to the measured values of the second sensor 54. In concurrent multiuse services, the measured values of the first sensor 53 may merge with the ancillary-service output; hence, it is not possible to calculate the peak-shift output using the measured values of the first sensor 53. In the peak cutting which aims to reduce basic electricity charges depending on the contract amperage, the power conditioning system 33 may calculate the peak-cut charge/discharge power using the measured values of the first sensor 53.

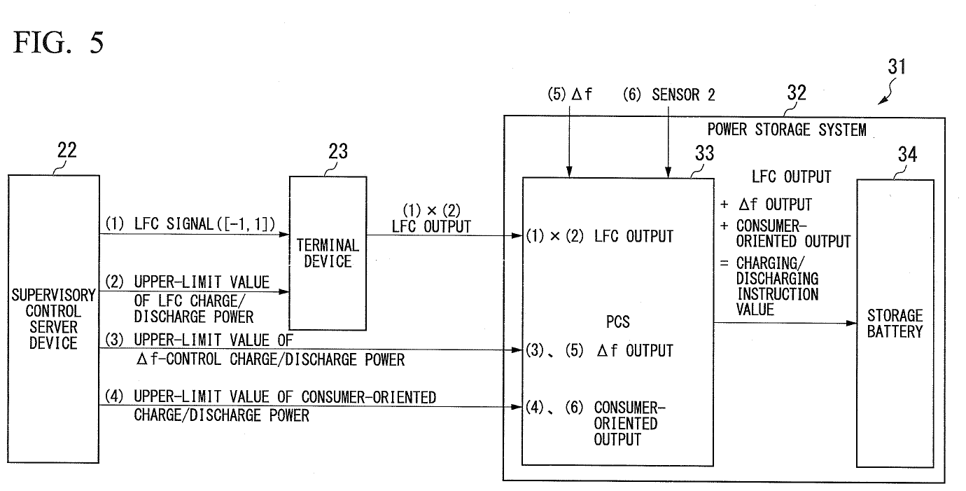

FIG. 5 shows an example of input/output data when the consumer-installed system 31 carries out services. FIG. 5 shows the consumer-installed system 31 configured to carry out an energy management service using the peak shifting or the peak cutting and an ancillary service using the LFC or the Δf control in a multiuse manner. In this connection, the energy management service will be referred to as a consumer-oriented service as well.

In FIG. 5, the supervisory control server device 22 is configured to output an LFC signal, an upper-limit value of LFC charge/discharge power, an upper-limit value of Δf charge/discharge power, and an upper-limit value of consumer-oriented charge/discharge power, which indicate electric energy allocated to a LFC service, a Δf control service, and a consumer-oriented service within an amount of chargeable or dischargeable electric energy of the power storage system 32. The supervisory control server device 22 is configured to set a total amount of upper-limit values (i.e. the upper-limit value of LFC charge/discharge power, the upper-limit value of Δf-control charge/discharge power, and the upper-limit value of consumer-oriented charge/discharge power) to fall within the rated power of the power storage system 32.

In the above, the upper-limit value of charge/discharge power means an upper-limit value of charge/discharge power. The supervisory control server device 22 may set the upper-limit value of charge/discharge power (e.g. the upper-limit value of LFC charge/discharge power, the upper-limit value of Δf-control charge/discharge power, or the upper-limit value of consumer-oriented charge/discharge power) such that the same value is set to charging power and discharging power or such that different values are set to charging power and discharging power. When the same value is set to charging power and discharging power, the supervisory control server device 22 may output a single common value as the upper-limit value of charge/discharge power with respect to charging power and discharging power. When different values are set to charging power and discharging power, the supervisory control server device 22 may output a combination of different values (or two values) as the upper-limit value of charge/discharge power with respect to charging power and discharging power. In this connection, the upper-limit value of charge/discharge power will be referred to as an upper-limit output value as well.

In addition, the supervisory control server device 22 transmit a LFC signal representing a ratio of LFC charge/discharge power to the upper-limit value of LFC charge/discharge power. Specifically, the supervisory control server device 22 may transmit a LFC signal representing a real number ranging from −1 to +1. Herein, the positive value of a LFC signal indicates discharging while the negative value of a LFC signal indicates charging. In this connection, the LFC charge/discharge power will be referred to as an LFC output as well.

The supervisory control server device 22 is configured to secure the upper-limit value of consumer-oriented charge/discharge power, i.e. a minimally-required output for a consumer-oriented service while allocating the remaining output to the upper-limit value of charge/discharge power for an ancillary service. Alternatively, the supervisory control service device 22 may secure the upper-limit value of ancillary-service charge/discharge power, i.e. a minimally-required output for an ancillary service, while allocating the remaining output to the upper-limit value of consumer-oriented charge/discharge power.

Using a LFC signal and an upper-limit value of LFC charge/discharge power among signals transmitted by the supervisory control server device 22, the terminal device 23 calculates a LFC output. As described above, the supervisory control server device 22 will output a LFC signal representing a ratio of the LFC output to the upper-limit value of LFC charge/discharge power. This makes it possible for the terminal device 23 to reproduce the LFC output by multiplying a real number indicated by the LFC signal by the upper-limit value of LFC charge/discharge power. The terminal device 23 calculates and transmits the LFC output to the power conditioning system 33.

The power conditioning system 33 calculates a Δf output and a consumer-oriented output, and therefore the power conditioning system 33 calculates a charging/discharging instruction value (representing the summation of the Δf output, the consumer-oriented output, and the LFC output received from the terminal device 23) to be sent to the storage battery 34. In this connection, the Δf output represents the charge/discharge power for the Δf control while the consumer-oriented output represents the charge/discharge power for a consumer-oriented service.

To calculate the Δf output, the power conditioning system 33 calculates a deviation of the system frequency to the reference frequency and then calculates its own share of the charge/discharge power used to cancel out the frequency deviation.

To calculate the consumer-oriented output, the power conditioning system 33 calculates a consumer-oriented output based on the measured values of the second sensor 54 (see FIG. 4). Subsequently, the power conditioning system 33 determines whether or not the consumer-oriented output falls within the upper-limit value of consumer-oriented charge/discharge power. Upon determining that the consumer-oriented output exceeds the upper-limit value of consumer-oriented charge/discharge power, the power conditioning system 33 reduces the consumer-oriented output to the upper-limit value of consumer-oriented charge/discharge power by removing a cutout. In this case, the value of X1 does not match the value of Y1, causing a deviation between X1 and Y1. The power conditioning system 33 produces a charging/discharging instruction value by adding up the LFC output, the Δf output, and the consumer-oriented output so as to charge or discharge power with the storage battery 34 according to the charging/discharging instruction value.

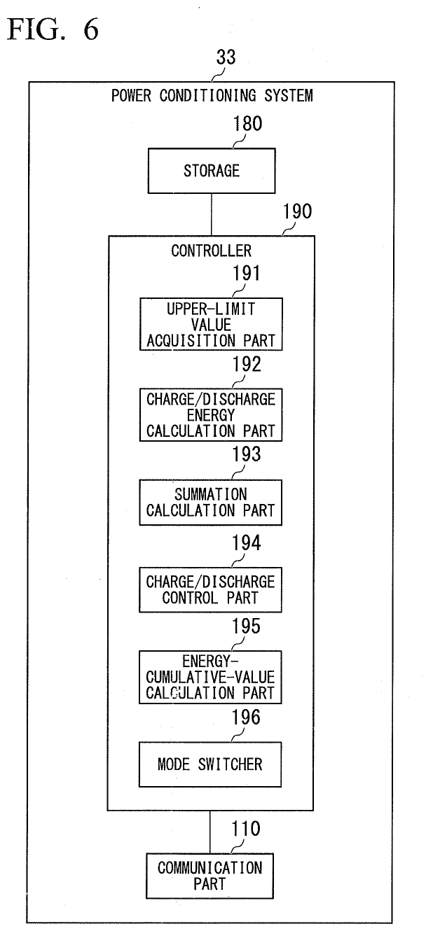

FIG. 6 shows an example of a functional configuration of the power conditioning system 33 applied to the storage battery 34 in the power storage system 32 shown in FIG. 1. In FIG. 6, the power conditioning system 33 includes a communication part 110, a storage 180, and a controller 190. The controller 190 further includes an upper-limit value acquisition part 191, a charge/discharge power calculation part 192, a summation calculation part 193, a charge/discharge control part 194, an energy-cumulative-value calculation part 195, and a mode switcher 196.

The communication part 110 is configured to communicate with other devices. In particular, the communication part 110 receives various data transmitted by the supervisory control server device 22 via the terminal device 23. The communication part 110 receives various data, which may include an upper-limit value of charge/discharge power for each service, a LFC signal, and various parameters used for the power conditioning system 33 to calculate Δf-control charge/discharge power, from the supervisory control server device 22. The communication part 110 transmits one or both of the system status information and the status information of the power storage system 32 such as a charging rate of the storage battery 34 to the supervisory control server device 22 via the terminal device 23. In this connection, the terminal device 23 may determine the upper-limit value of charge/discharge power for each service. In this case, the terminal device 23 may transmit the upper-limit value of charge/discharge power for each service to the supervisory control service device 22 as the status information of the power storage system 32.

In this connection, the status information of the power storage system 32 may include a charging rate (SOC) of the storage battery 34, a chargeable/dischargeable power value, a power value generated by a solar power generation system connected to the power storage system 32, a consumer-load power value, a deterioration status of the power storage system 32, the frequency-controlling status (as to whether or not to carry out an ancillary service), a status of a consumer-oriented energy management service (representing a type of an energy management service), and a system-cooperation status as well as other pieces of information such as failure or error condition information. In addition, the communication part 110 transmits the cumulative value of electric energy calculated by the energy-cumulative-value calculation part 195 to the terminal device 23, or the communication part 110 transmits the cumulative value of electric energy to the supervisory control server device 22 via the terminal device 23.

The storage 180 is configured to store various types of data. The function of the storage 180 is implemented using a storage device installed in the power conditioning system 33. The controller 190 is configured control the functional parts of the power conditioning system 33 to execute various processes. A CPU (Central Processing Unit) of the power conditioning system 33 reads programs from the storage 180 and then executes programs to achieve the function of the controller 190.

The upper-limit value acquisition part 191 is configured to acquire the upper-limit value of charge/discharge power transmitted by the supervisory control server device 22 with respect to a service to calculate the charge/discharge power with the charge/discharge power calculation part 192. Specifically, the upper-limit value acquisition part 191 extracts the upper-limit value of charge/discharge power from a received signal which the communication part 110 receives from the supervisory control server device 22 via the terminal device 23.

The charge/discharge power calculation part 192 is configured to calculate an amount of charge/discharge power for each service. In FIG. 5, for example, the charge/discharge power calculation part 192 is configured to calculate a Δf output and a consumer-oriented output. Specifically, the charge/discharge power calculation part 192 calculates an amount of charge/discharge power based on the upper-limit value of charge/discharge power which is set by the supervisory control server device 22. In particular, the charge/discharge power calculation part 192 calculates an amount of charge/discharge power for each service within the upper-limit value of charge/discharge power which is set by the supervisory control server device 22 (i.e. within a range between an upper-limit value of charging power and an upper-limit value of discharging power).

In addition, the supervisory control server device 22 may calculates an upper-limit value of charge/discharge power for each service and a ratio of charge/discharge power to the upper-limit value of charge/discharge power. For example, the supervisory control server device 22 may calculate the ratio ranging from −1 to +1 (where the positive value indicates charging while the negative value indicates discharging), thus indicating an amount of charge/discharge power within a range between an upper-limit charging value and an upper-limit discharging value. In the power conditioning system 33, the charge/discharge power calculation part 192 is able to calculate an amount of charge/discharge power by way of a simple calculation for multiplying the ratio calculated by the supervisory control server device 22 by the upper-limit value of charge/discharge power transmitted by the supervisory control server device 22.

Alternatively, as described above, the terminal device 23 instead of the power conditioning system 33 may calculate an amount of charge/discharge power with respect to at least part of services. In this case, the terminal device 23 is able to calculate an amount of charge/discharge power by way of a simple calculation for multiplying the ratio calculated by the supervisory control server device 22 by the upper-limit value of charge/discharge power.

The present embodiment refers to an example of the power conditioning system 33 configured to detect a frequency deviation Δf (i.e. a deviation of the system frequency from the reference frequency), however, the supervisory control server device 22 may detect a frequency deviation Δf. In this case, the supervisory control server device 22 may transmit a frequency deviation Δf representing a normalized value ranging from −1 to +1. When the Δf control is applied to a frequency range of 50 Hz±0.2 Hz, for example, the supervisory control server device 22 may calculate and transmit a normalized value of ±1 as a frequency deviation of ±0.2 Hz. Accordingly, the power conditioning system 33 (or the terminal device 23) is able to calculate an amount of charge/discharge power by way of a simple calculation for multiplying the normalized control value by the upper-limit value of Δf-control charge/discharge power.

The summation calculation part 193 is configured to produce a summation of charge/discharge power for each service calculated by the terminal device 23 and the charge/discharge power calculation part 192. The summation calculation part 193 produces the summation as a charging/discharging instruction value (e.g. a value to instruct the storage battery 34 to charge or discharge its power) to the storage battery 34.

The charge/discharge controller 194 controls the storage battery 34 to charge or discharge its power based on the summation produced by the summation calculation part 193.

Therefore, the power conditioning system 33 may calculate an amount of charge/discharge power using the received value of charge/discharge power with respect to a service receiving the value of charge/discharge power. With respect to another service not receiving the value of charge/discharge power, the power conditioning system 33 may calculate an amount of charge/discharge power by itself (actually by the charge/discharge power calculation part 192), and then the summation calculation part 193 may produce the summation of the received value of charge/discharge power or the calculated value of charge/discharge power, thus controlling the storage battery 34 to charge or discharge its power.

The energy-cumulative-value calculation part 195 calculates cumulative values of electric energy with respect to charging power for each service and discharging power for each service as well as charging power and discharging power of the storage battery 34. The cumulative values calculated by the energy-cumulative-value calculation part 195 are used to calculate incentive payments for contributions to ancillary services (or for provision of charging/discharging functions).

Accordingly, it is possible to finely calculate incentive payments by means of the energy-cumulative-value calculation part configured to calculate cumulative values of electric energy with respect to charging power for each service and discharging power for each service as well as charging power and discharging power of the storage battery 34.

Among a plurality of services classified into a consumer-oriented service and a system-oriented service, the mode switcher 196 is configured to switch a first mode for carrying out the consumer-oriented service alone and a second mode for carrying out both the consumer-oriented service and the system-oriented service. Owing to the mode switcher 196 configured to switch the first mode and the second mode, for example, the first mode for carrying out the consumer-oriented service alone is not necessarily restricted to the upper-limit value of charge/discharge power which is set by the supervisory control server device 22; hence, it is possible to provide any services meeting the demand of consumers.

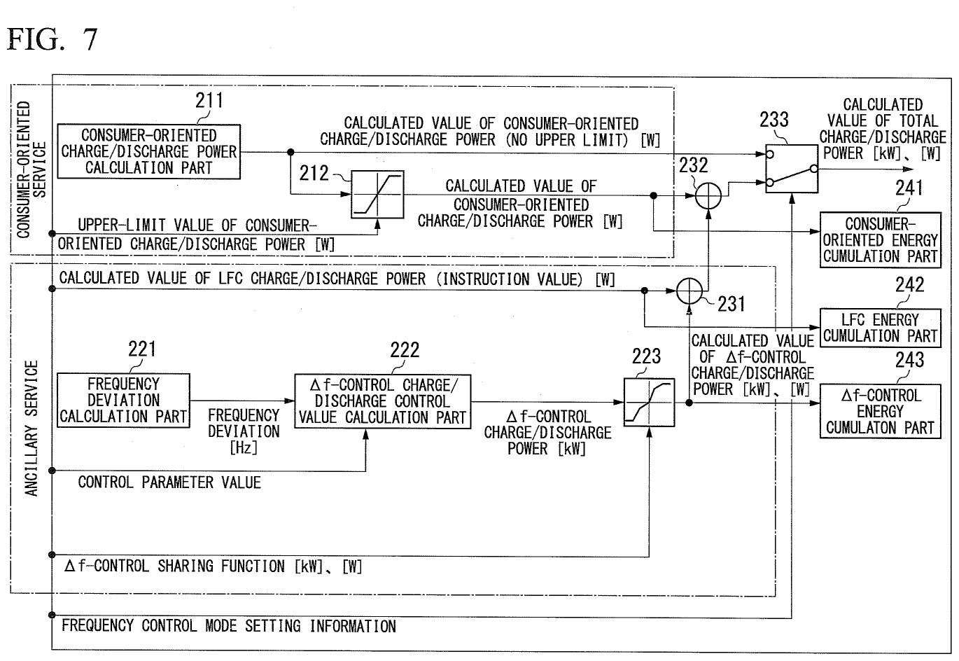

FIG. 7 shows another example of the functional configuration of the power conditioning system 33. FIG. 7 shows specific configuration examples with respect to the charge/discharge power calculation part 192, the summation calculation part 193, the energy-cumulative-value calculation part 195, and the mode switcher 196 among the functional parts of the controller 190 of the power conditioning system 33 shown in FIG. 6. At least part of the configuration of FIG. 7 can be configured of hardware or implemented by software.

In FIG. 7, the power conditioning system 33 includes a consumer-oriented charge/discharge power calculation part 211, a limiter 212 (for limiting consumer-oriented charge/discharge power to be lower than its upper-limit value), a frequency deviation calculation part 221, a Δf-control charge/discharge power control value calculation part 222, a Δf-control sharing function calculation part 223, a first adder 231, a second adder 232, a switch 233, a consumer-oriented energy cumulation part 241, a LFC energy cumulation part 242, and a Δf-control energy cumulation part 243.

The consumer-oriented charge/discharge power calculation part 211 has a function to calculate an amount of charge/discharge power [W] similar to the conventional function of a battery charger. The consumer-oriented charge/discharge power calculation part 211 is configured to calculate a control value using the measured value(s) of a local CT (Current Transformer) sensor (e.g. the second sensor 54 shown in FIG. 4).

To concurrently implement consumer-oriented charging and discharging together with frequency-control-oriented charging and discharging, the limiter 212 is configured to set the upper-limit value of consumer-oriented charging power [W] and the upper-limit value of consumer-oriented discharging power [W].

The frequency deviation calculation part 221 is configured to measure the system frequency and to thereby calculates a frequency deviation [mHz] of the system frequency to the reference frequency (e.g. 50 Hz or 60 Hz).

The Δf-control charge/discharge power control value calculation part 222 is configured to calculate a control value of charge/discharge power [kW] against the frequency deviation (A1).

In the above, the supervisory control server device 22 serving as a host device may set parameters necessary for calculations so as to transmit parameters to the power conditioning system 33 via the terminal device 23.

The Δf-control shared function calculation part 223 is configured to calculate a Δf-control charging/discharging instruction value [W]. Herein, the supervisory control server device 22 serving as a host device may set parameters necessary for calculations so as to transmit parameters to the power conditioning system 33 via the terminal device 23.

A combination of the consumer-oriented charge/discharge power calculation part 211, the limiter 212, the frequency deviation calculation part 221, the Δf-control charge/discharge power control value calculation part 222, and the Δf-control shared function calculation part 223 may exemplifies an example of the charge/discharge power calculation part 192.

The first adder 231 and the second adder 232 are configured to carry out additions respectively. Using a combination of the first adder 231 and the second adder 232, it is possible to calculate the total charge/discharge power corresponding to the summation of the consumer-oriented charge/discharge power [W], the LFC charge/discharge power [W], and the Δf-control charge/discharge power [W]. The total charge/discharge power may serve as an instruction value applied to the storage battery 34. A combination of the first adder 231 and the second adder 232 may exemplify an example of the summation calculation part 193.

The switch 233 is configured to switch modes as to whether or not to use concurrent multiuse services. In a mode not using concurrent multiuse services, the output of the consumer-oriented charge/discharge power calculation part 211 is directly used as the calculated value of total charge/discharge power without being limited by the limiter 212. In another mode using concurrent multiuse services, the limiter 212 is applied to the output of the consumer-oriented charge/discharge power calculation part 211, and therefore the summation of the calculated value of LFC charge/discharge power and the calculated value of Δf-control charge/discharge power is used as the calculated value of total charge/discharge power. In this connection, the switch 233 may exemplify an example of the mode switcher 196.

The consumer-oriented energy cumulation part 241 is configured to cumulate the calculated values of consumer-oriented charge/discharge power. In particular, the consumer-oriented energy cumulation part 241 classifies cumulation patterns into four patterns, which are determined according to two patterns as to whether the calculated value of consumer-oriented charge/discharge power is related to either charging power or discharging power and other two patterns as to whether the calculated value of total charge/discharge power is related to either charging power or discharging power, and therefore the consumer-oriented energy cumulation part 241 cumulates the calculated values of consumer-oriented charge/discharge power according to four patterns.

When consumer-oriented services charge usage-based rates for consumers, for example, the cumulative values of the consumer-oriented energy cumulation part 241 can be used to calculate charges to consumers. In addition, consumers may confirm how much benefit will be received according to consumer-oriented services with reference to the cumulative values of the consumer-oriented energy cumulation part 241.

The LFC energy cumulation part 242 is configured to cumulate the calculated values of LFC charge/discharge power. In particular, the LFC energy cumulation part 242 classifies cumulation patterns into four patterns, which are determined according to two patterns as to whether the calculated value of LFC charge/discharge power is related to either charging power or discharging power and other two patterns as to whether the calculated value of total charge/discharge power is related to either charging power or discharging power, and therefore the LFC energy cumulation part 241 cumulates the calculated values of LFC charge/discharge power according to four patterns.

The cumulative values of the LFC energy cumulation part 242 can be used to calculate incentive payments for consumers' contribution to ancillary services. In addition, consumers may confirm how much contribution will be devoted to the LFC with reference to the cumulative values of the LFC energy cumulation part 242.

The Δf-control energy cumulation part 243 is configured to cumulate the calculated values of Δf-control charge/discharge power. In particular, the Δf-control energy cumulation part 243 classifies cumulation patterns into four patterns, which are determined according to two patterns as to whether the calculated value of Δf-control charge/discharge power is related to either charging power or discharging power and other two patterns as to whether the calculated value of total charge/discharge power is related to either charging power or discharging power, and therefore the Δf-control energy cumulation part 243 cumulates the calculated values of Δf-control charge/discharge power according to four patterns.

The cumulative values of the Δf-control energy cumulation part 243 can be used to calculate incentive payments for consumers' contribution to ancillary services. In addition, consumers may confirm how much contribution will be devoted to the Δf control with reference to the cumulative values of the Δf-control energy cumulation part 243.

In this connection, each of or a combination of the consumer-oriented energy cumulation part 241, the LFC energy cumulation part 242, and the Δf-control energy cumulation part 243 may exemplify an example of the energy-cumulative-value calculation part 195.

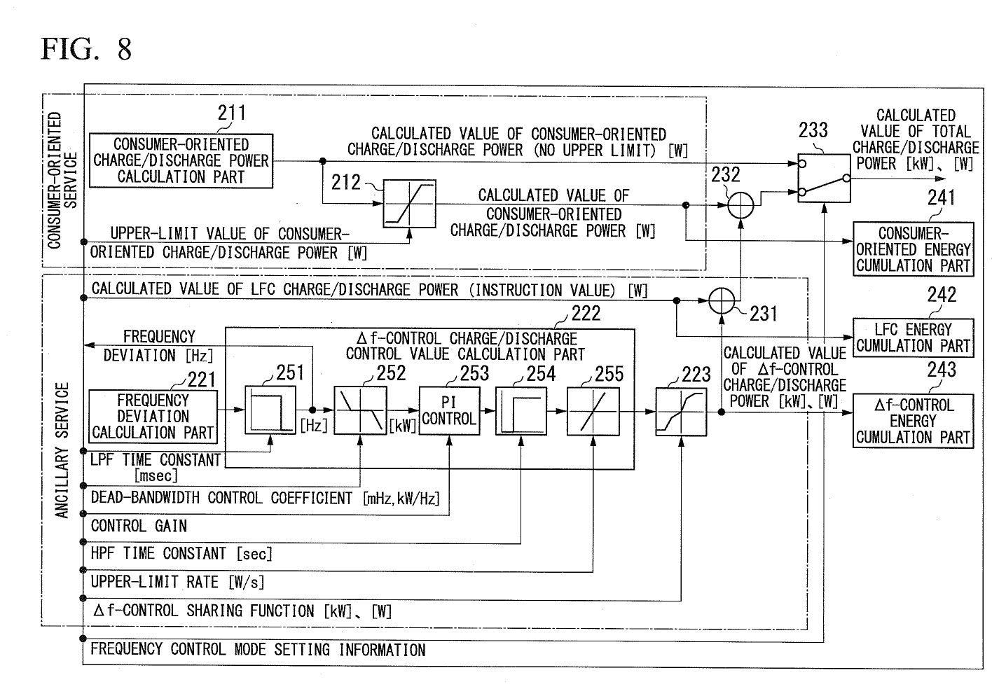

FIG. 8 shows a further example of the functional configuration of the power conditioning system 33. FIG. 8 shows the further detailed configuration compared to FIG. 7 with respect to the Δf-control charge/discharge power control value calculation part 222, which further includes a low-pass filter (LPF) 251, a dead-band setting part 252, a PI (Proportional-Integral) control part 253, a high-pass filter (HPF) 254, and a rate-limiter 255.

The low-pass filter 251 eliminates short-period components from frequency deviations (Δf) calculated by the frequency deviation calculation part 221. The supervisory control server device 22 provides a time constant (τ) of the low-pass filter 251, for example, which is set to a range between 0 milliseconds and 65.535 milliseconds. For example, the cutoff frequency of the low-pass filter 251 would be ½πτ.

The dead-band setting part 252 sets a dead bandwidth (e.g. a bandwidth ranging between 0.000 mHz and 1,000 mHz in either the positive side and the negative side) with respect to frequency deviations (Δf) after low-pass filtering, thus converting frequency deviations (Δf) into an amount of charge/discharge power [kW]. In this connection, the supervisory control server device 22 provides a setting value of a dead bandwidth (e.g. dead-bandwidth control coefficient [mHz, kW/Hz]).

The PI control part 253 carries out a PI control for charge/discharge power [kW] calculated by the dead-band setting part 252, whereas the PI control part 253 simply applies a PI gain to the charge/discharge power without making a feedback control. Herein, a feedback may be reflected in Δf values via reaction of the power system. The supervisory control server device 22 provides a P-gain and an I-gain to the PI control part 253, wherein each of the P-gain and the I-gain is set with a range between 0.000 and 10.000.

The high-pass filter 254 eliminates long-period components from control values calculated by the PI control part 253. The supervisory control server device 22 provides a time constant (τ) of the high-pass filter 254, for example, which is set within a range between 0.0 seconds and 6,553.5 seconds. For example, the cutoff frequency of the high-pass filter 254 would be set to ½πτ.

The rate-limiter 255 sets an upper-limit rate to varying rates of PI control values [kW/s, W/s] after high-pass filtering. The supervisory control server device 22 provides the upper-limit rate of the rate-limiter 255.

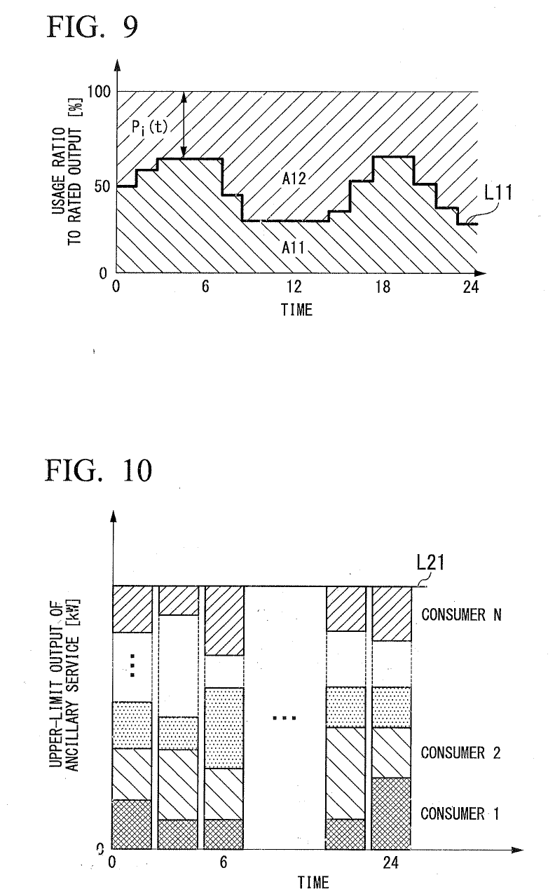

Next, examples of setting upper-limit values of charge/discharge power will be described with reference to FIGS. 9 and 10.

FIG. 9 shows an example of output usage ratios for each service with the power storage system 32 in the consumer-installed system 31 own by a certain consumer. The horizontal axis of FIG. 9 represents time while the vertical axis represents “usage ratio to rated output (of power storage system)”, i.e. the upper-limit values for consumer-oriented services and ancillary services to be each expressed as a ratio of the upper-limit output of the power storage system 32 to the rated output of the power storage system 32.

FIG. 9 shows a varying line L11 to divide the entire graphical area into a lower region A11 and an upper region A12. The lower region A11 depicted below the varying line L11 and above the usage ratio of 0% shows the upper-limit output of the power storage system 32 for consumer-oriented services along with time zones. Similarly, the upper region A12 depicted above the varying line L11 and below the usage ratio of 100% shows the upper-limit output of the power storage system 32 for ancillary services along with time zones. FIG. 9 shows an upper-limit output Pᵢ(t) of the power storage system 32 with respect to a service i (where i denotes an index to identify each service) at time t.

In the above, the supervisory control server device 22 may provide an instruction by further dividing at least one of the upper-limit output for an ancillary service and the upper-limit output for a consumer-oriented service. In FIG. 5, the supervisory control server device 22 further divides the upper-limit output for an ancillary service into an upper-limit value of LFC charge/discharge power and an upper-limit value of Δf-control charge/discharge power.

With respect to each of charging power and discharging power, the supervisory control server device 22 sets the upper-limit output of the power storage system 32 for a consumer-oriented service and the upper-limit output of the power storage system 32 for an ancillary service every predetermined time (e.g. ten minutes and several minutes) such that the summation of those upper-limit outputs will become equal to the rated output of the power storage system 32. In this connection, the supervisory control server device 22 may set the same value to both the upper-limit value of charging power and the upper-limit value of discharging power, or the supervisory control server device 22 may set different values to the upper-limit value of charging power and the upper-limit value of discharging power. Alternatively, the terminal device 23 may set the upper-limit value of charge/discharge power of the power storage system 32 for consumer-oriented services.

FIG. 10 shows bar graphs which are produced by heaping up upper-limit outputs of consumer-oriented charge/discharge power for consumers' ancillary services. In FIG. 10, the horizontal axis represents time while the vertical axis represents “upper-limit output of ancillary service”. FIG. 10 shows a line L21 representing the total value of bars (each summing upper-limit outputs of ancillary services for consumers 1 through N where N denotes an arbitrary integer).

As described above, the supervisory control server device 22 sets the upper-limit output of ancillary services for each consumer every predetermined time. As shown in FIG. 10, the supervisory control server device 22 sets the upper-limit output of ancillary services for each consumer so as to secure the total amount of adjustment power which is produced by adding up upper-limit outputs of ancillary services for all consumers, i.e. a predetermined value indicated by the line L21 in FIG. 10.

The supervisory control server device 22 supervises the status of individual storage batteries (e.g. the varying number of storage batteries available in outputting power due to a failure or another factor), adjusts a ratio of an upper-limit output of a storage battery for each consumer allocated to ancillary services at any appropriate timings, and thereby stabilizes the total amount of outputs of storage batteries available to ancillary services. That is, the supervisory control server device 22 is configured to continuously maintain the total amount of adjustment power available to ancillary services at a required value.

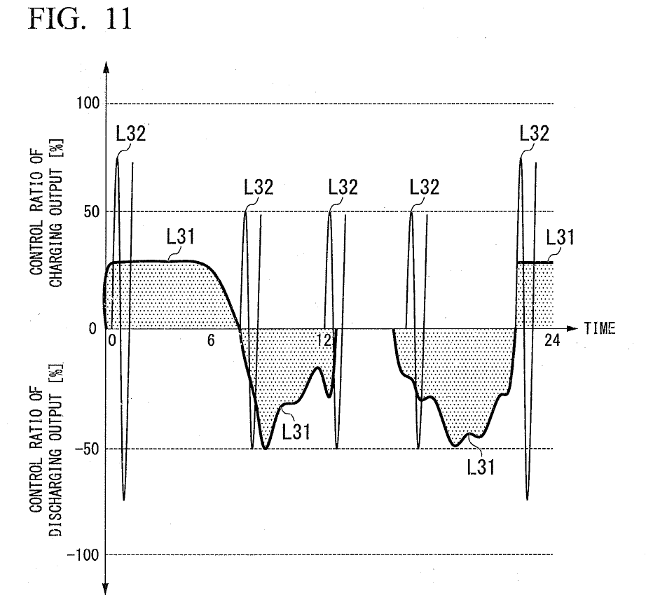

Next, an example of the output of the power storage system 32 will be described with reference to FIG. 11. FIG. 11 shows an example of transition of controlling the output of the power storage system 32 allocated to services. In FIG. 11, the horizontal axis represents time while the vertical axis represents a control ratio of a charge/discharge output to the rated output of the power storage system 32 with respect to services, wherein the charging output is expressed using a positive value while the discharging output is expressed using a negative value.

FIG. 11 shows varying lines L31 and L32 which are varying over time. The varying line L31 shows a control ratio of the output of consumer-oriented services mainly using energy in units of kilowatt hours [kWh]. The varying line L32 shows a control ratio of the output of ancillary services mainly using power in units of kilowatts [kW]. FIG. 11 shows various time zones in which the power storage system 32 may provide both the output of consumer-oriented services (see the varying line L31) and the output of ancillary services (see the varying line L32). This indicates events to concurrently carry out consumer-oriented services and ancillary services.

For example, it is assumed that consumer-oriented services (see the varying line L31) will be implemented via peak shifting of nighttime charging and daytime discharging using the power storage system 32 having the rated output of 3 kW and the storage battery 43 having the rated output of 6 kWh. Herein, the power storage system 32 would secure the upper-limit output of consumer-oriented power for consumer-oriented services at ±1.5 kW while allocating the remaining output to ancillary services (see varying line 32) for a general power transmission/distribution business operator. The supervisory control server device 22 and the power conditioning system 33 exchange various pieces of information to calculate the output of ancillary services, which may include an instruction value of charge/discharge power using a LFC signal and a Δf-control shared function.

In a long-period service for fully charging power in a specific time zone ranging from 23 o'clock to 7 o'clock, the power storage system 32 needs an effective charging output of 0.75 kW. In this case, the supervisory control server device 22 determines to charge power up to the upper-limit output of the power storage system 32 for peaking shifting at 0.75 kW, and therefore the power storage system 32 charges power at 0.75 kW in a time zone from 23 o'clock to 7 o'clock.

In addition, the supervisory control server device 22 determines the upper-limit output of the power storage system 32 for ancillary services at 2.25 kW (=3 kW−0.75 kW), wherein the power storage system 32 may charge or discharge power using 2.25 kW amplitudes (LFC) for short-period adjustment power (for use in the LFC and the Δf control).

For example, the power storage system 32 may charge or discharge power at 0.75t+2.25·An(t), where t denotes time. In addition, An(t) denotes a function representing adjustment power (or an adjustment-power function) (where −1≤An(t)≤+1), where An(t) is a periodical value.

Assuming that a transition from nighttime charging to daytime discharging needs effective discharge residual power of 1.5 kW, for example, the power storage system 32 needs to charge or discharge power according to −1.5f(t)+1.5·An(t), where f(t) denotes a demand function (i.e. a function representing a consumer-oriented output) where 0≤f(t)≤1. For example, f(t) can be calculated using the value of the second sensor 54, which has been discussed above with reference to FIG. 4, requiring an instantaneous response. Owing to the aforementioned controls, it is possible to maximally utilize the rated charge/discharge power of ±3 kW of the power storage system 32 for services.

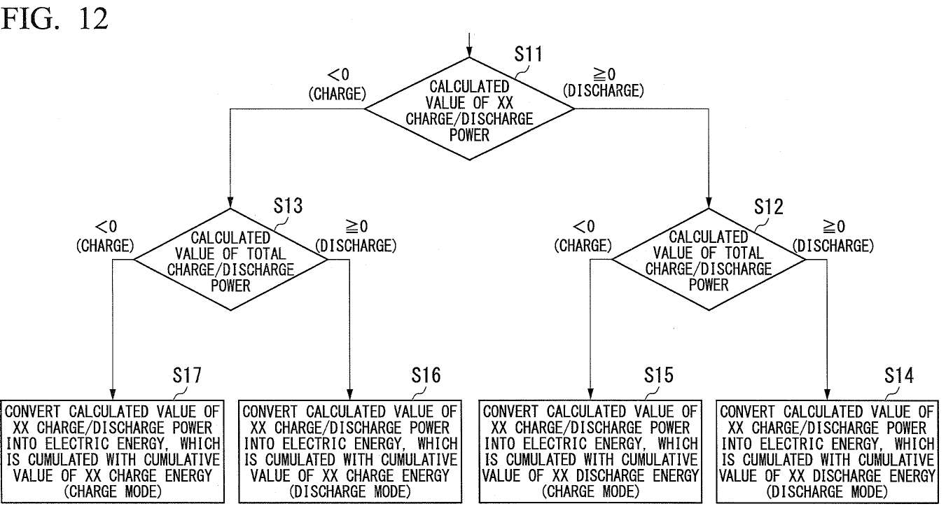

Next, a process to calculate cumulative values of electric energy will be described with reference to FIG. 12. FIG. 12 shows an example of a process to calculate cumulative values of electric energy by the consumer-oriented energy cumulation part 241, the LFC energy cumulation part 242, and the Δf-control energy cumulation part 243 (see steps S11 to S17). Herein, the consumer-oriented energy cumulation part 241, the LFC energy cumulation part 242, and the Δf-control energy cumulation part 243 will collectively be referred to as an energy cumulation part. The energy cumulation part repeatedly carries out the process of FIG. 12 every sampling period (e.g. a timing to issue a charging/discharging instruction such as ten milliseconds).

In the process of FIG. 12, the energy cumulation part determines whether or not the calculated value of charge/discharge power subjected to cumulation (i.e. an amount of charge/discharge power for each cumulation service) is zero or more (S11), wherein charging power is indicated by a positive value of charge/discharge power while discharging power is indicated by a negative value of charge/discharge power. For convenience sake, FIG. 12 shows that zero value of charge/discharge power (indicating no charging/discharging operations) is included in discharging power, but it can be included in charging power, or zero value of charge/discharge power can be applied to another process other than charging power and discharging power.

In FIG. 12, the notation of “xx charge/discharge power” indicates an amount of charge/discharge power for each cumulation service. In the case of the energy cumulation part serving as the consumer-oriented energy cumulation part 241, the charge/discharge power subjected to cumulation indicates the consumer-oriented charge/discharge power. In the case of the energy cumulation part serving as the LFC energy cumulation part 242, the charge/discharge power subjected to cumulation indicates the LFC charge/discharge power. In the case of the energy cumulation part serving as the Δf-control energy cumulation part 243, the charge/discharge power subjected to cumulation indicates the Δf-control charge/discharge power.

Upon determining that the calculated value of charge/discharge power subjected to cumulation is zero or more (S11, YES), the energy cumulation part determines whether or not the calculated value of total charge/discharge power (i.e. the output of the power storage system 32) is zero or more (S12).

Upon determining that the calculated value of total charge/discharge power is zero or more (S12, YES), the energy cumulation part converts the calculated value of charge/discharge power subjected to cumulation into electric energy, which is cumulated with the cumulative value of discharging energy (discharge mode) (S14). After step S14, the energy cumulation part exits the process of FIG. 12.

In FIG. 12, the notation of “cumulative value of xx discharging energy” indicates the cumulative value of charge/discharge power for each cumulation service when an amount of charge/discharge power for each cumulation service indicates an amount of discharge power. In addition, the notation of “cumulative value of charge energy” indicates the cumulative value of charge/discharge power for each cumulation service when an amount of charge/discharge power for each cumulation service indicates an amount of charge power. In steps S14 through S17, the notations of “charge mode” and “discharge mode” indicate a charge mode to charge the total charge/discharge power and a discharge mode to discharge the total charge/discharge power respectively.

Upon determining that the calculated value of total charge/discharge power is a negative value in step S12 (i.e. S12, NO), the energy cumulation part converts the calculated value of charge/discharge power for each cumulation service into electric energy, which is then cumulated with the cumulative value of charge/discharge energy for each cumulation service (charge mode) (S15). After step S15, the energy cumulation part exits the process of FIG. 12.

Upon determining that the calculated value of total charge/discharge power for each cumulation service is a negative value (S11, NO), the energy cumulation part determines whether or not the calculated value of total charge/discharge power is zero or more (S13).

Upon determining that the calculated value of total charge/discharge power is zero or more (S13, YES), the energy cumulation part converts the calculated value of charge/discharge power for each cumulation service into electric energy, which is then cumulated with the cumulative value of charge/discharge energy (discharge mode) (S16). After step S16, the energy cumulation part exits the process of FIG. 12.

Upon determining that the calculated value of total charge/discharge power is a negative value (S13, NO), the energy cumulation part converts the calculated value of charge/discharge power for each cumulation service into electric energy, which is then cumulated with the cumulative value of charge/discharge energy for each cumulation service (charge mode) (S17). After step S17, the energy cumulation part exits the process of FIG. 12.

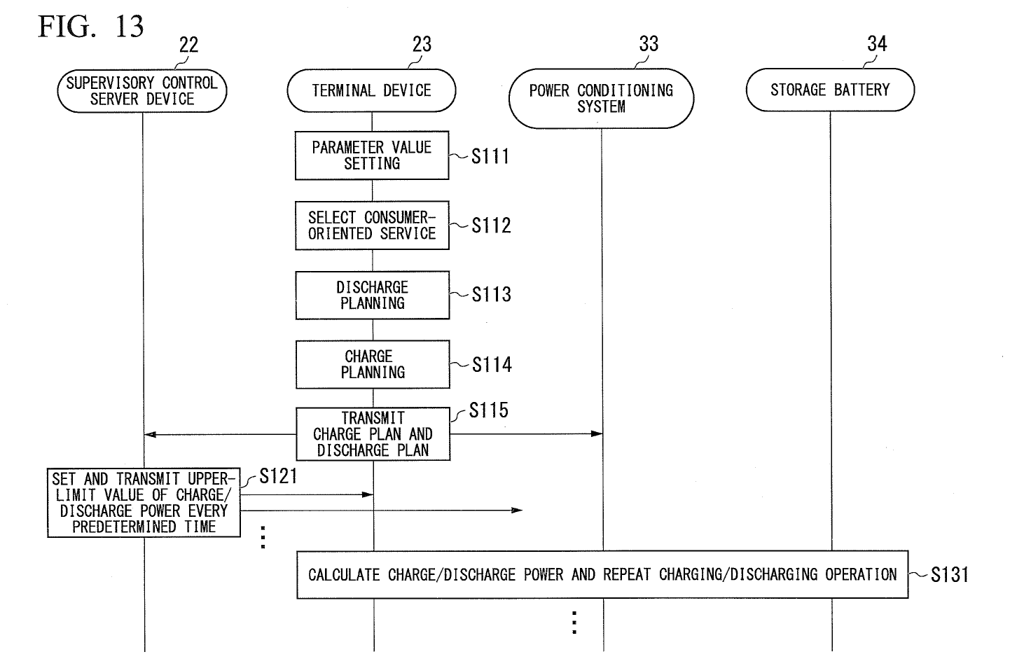

Next, an operation example of the power system 1 will be described below. FIG. 13 shows an example of a process to carry out services by the power system 1 (i.e. steps S111 through S115, S121 and S131). First, parameter values (a) through (c) will be set below (S111).

(a) Upper-limit output of consumer-oriented services: Pe=±2 kW (where a positive value indicates discharging while a negative value indicates charging)

(b) Variable range of the capacity (SOC) Q of the storage battery 34: +5%≤Q≤+95%

(c) Upper-limit output of ancillary services: Pa=±1.3 kW (where a positive value indicates discharging while a negative value indicates charging)

For example, a consumer (i.e. a user of the consumer-installed system 31) may operate the terminal device 23 to set parameter values.

A consumer may select any one of consumer-oriented services presented by the terminal device 23 (S112). Herein, it is assumed that the consumer will select peak shifting (e.g. seasonal charges, nighttime charging and daytime discharging). The peak shifting has one cycle of twenty-four hours is designed to charge power in a time zone claiming the lowest electricity charges but to discharge power in an order of time zones claiming higher electricity charges in consideration of electricity demands. For example, a time zone from 10 o'clock to 17 o'clock claims the highest electricity charges; a time zone from 7 o'clock to 10 o'clock and a time zone from 17 o'clock to 23 o'clock claim the second highest electricity charges; and a time zone from 23 o'clock to 7 o'clock claims the lowest electricity charges.

For example, the terminal device 23 serving as an EMS terminal is configured to predict electricity demands for twenty-four hours from 7 o'clock (i.e. an end time of a time zone claiming the lowest electricity charges) to 7 o'clock in the next morning and to thereby make a discharge plan to discharge the charged power as much as possible within the upper-limit output Pe [W] secured for consumer-oriented services (S113). For example, the terminal device 23 may predict dischargeable energy to be discharged in a time zone from 10 o'clock to 17 o'clock claiming the highest electricity charges so as to make a discharge plan to discharge deficient energy (i.e. residual charged power) in a time zone from 7 o'clock to 10 o'clock and a time zone from 17 o'clock to 23 o'clock.

The terminal device calculates necessary charged power needed in a time zone from 23 o'clock to 7 o'clock according to the discharge plan (S114). In this connection, the terminal device 23 calculates the charged power according to an example of a charge plan. The terminal device 23 transmits the discharge plan and the calculated value of charged power (i.e. the charge plan) to the supervisory control server device 22 and the power conditioning system 33 (S115).

According to the discharge plan and the charge plan from the terminal device 23, the supervisory control server device 22 sets the upper-limit value of charge/discharge power for each service with respect to the consumer-installed system 31 equipped with the terminal device 23, thus transmitting the upper-limit value of charge/discharge power to the terminal device 23 and the power conditioning system 33 (S121). As described above, the supervisory control server device 22 is configured to set the upper-limit value of charge/discharge power every predetermined time (e.g. fifteen minutes).

The terminal device 23 and the power conditioning system 33 will repeat calculating an amount of charge/discharge power and controlling storage batteries according to the discharge plan, the charge plan, and the upper-limit value of charge/discharge power which is calculated by the supervisory control server device 22 (S131).

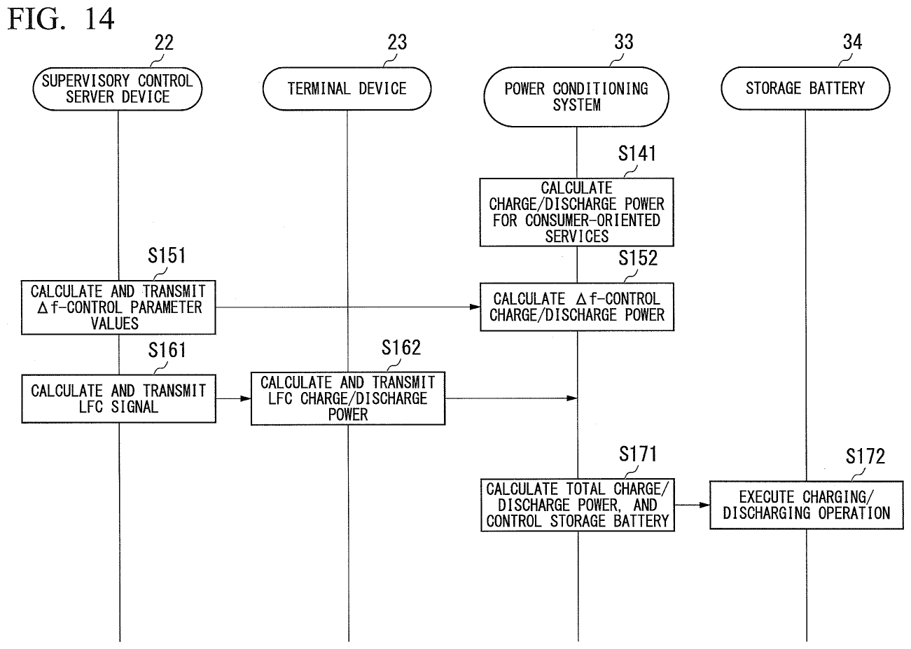

FIG. 14 shows a first example of a process to calculate an amount of charge/discharge power and to control the storage battery 34 (see steps S141, S151, S152, S161, S162, S171, and S172). In step S131 of FIG. 13, the terminal device 23, the power conditioning system 33, and the storage battery 34 cooperate together to carry out the process of FIG. 14. In the process of FIG. 14, the power conditioning system 33 calculates an amount of charge/discharge power for consumer-oriented services (e.g. peak shifting) according to the discharge plan and the charge plan made by the terminal device 23 and the upper-limit value of charge/discharge power transmitted by the supervisory control server device 22 (S141).

According to the discharge plan, for example, the power conditioning system 33 discharges power with the storage battery 34 (without causing a reverse power flow) in a time zone from 7 o'clock to 10 o'clock up to the upper limit of deficient power which cannot be discharged in a time zone from 10 o'clock to 17 o'clock. Subsequently, the power conditioning system 33 discharges the planned power with the storage battery 34 (without causing a reverse power flow) in a time zone from 10 o'clock to 17 o'clock. Moreover, the power conditioning system 33 discharges deficient power, which cannot be discharged in previous time zones, with the storage battery 34 (without causing a reverse power flow) in a time zone from 17 o'clock to 23 o'clock up to the lower-limit setting value of SOC (e.g. 5%). In the above, the expression “without causing a reverse power flow” indicates a range of power required by peak-shifting services not causing a reverse power flow, whereas ancillary services may allow for a reverse power flow.

The power conditioning system 33 discharges energy P, which is secured for the planned discharge, with the storage battery 34 in a time zone claiming the lowest electricity charges (e.g. a time zone from 23 o'clock to 7 o'clock) up to the upper-limit setting value of SOC (e.g. 95%). In this connection, the charging-start timing is not immediate at 23 o'clock, but it is possible to appropriately delay the charging-start timing to prevent concentration of charging. In this connection, the power conditioning system 33 may receive instructions representing an amount of charging and the charging timing from the supervisory control server device 22.

If it is not possible to predict electricity demand, the power conditioning system 33 may charge power with the storage battery 34 as much as possible in a time zone claiming the lowest electricity charges (e.g. a time zone from 23 o'clock to 7 o'clock) up to the upper-limit setting value of SOC (e.g. 95%). After expiration of the time zone claiming the lowest electricity charges, the power conditioning system 33 may discharge power with the storage battery 34 as much as possible without causing a reverse power flow.

During consumer-oriented services, the power system 1 may carry out ancillary services in parallel to consumer-oriented services. Specifically, the supervisory control server device 22 calculates and transmits Δf-control parameter values to power conditioning system 33 (S151). The power conditioning system 33 calculates Δf-control charge/discharge power using parameter values within the upper-limit value of charge/discharge power (S152).

The supervisory control server device 22 calculates and transmits a LFC signal to the terminal device 23 (S161). The terminal device 23 calculates LFC charge/discharge power according to the LFC signal and the upper-limit value of charge/discharge power, thus transmitting the LFC charge/discharge power to the power conditioning system 33 (S162).

The power conditioning system 33 calculates total charge/discharge power totaling charge/discharge power for each service so as to control the storage battery 34 according to the total charge/discharge power (S171). Under the control of the power conditioning system 33, the storage battery 34 may charge or discharge power (S172).

As described above, an allowable delay time of LFC is longer than an allowable delay time of consumer-oriented services and an allowable delay time of Δf control. For this reason, the power conditioning system 33 may calculate the total charge/discharge power on the condition that the LFC charge/discharge power will maintain its previously-calculated value without involving a further calculation of LFC charge/discharge power.

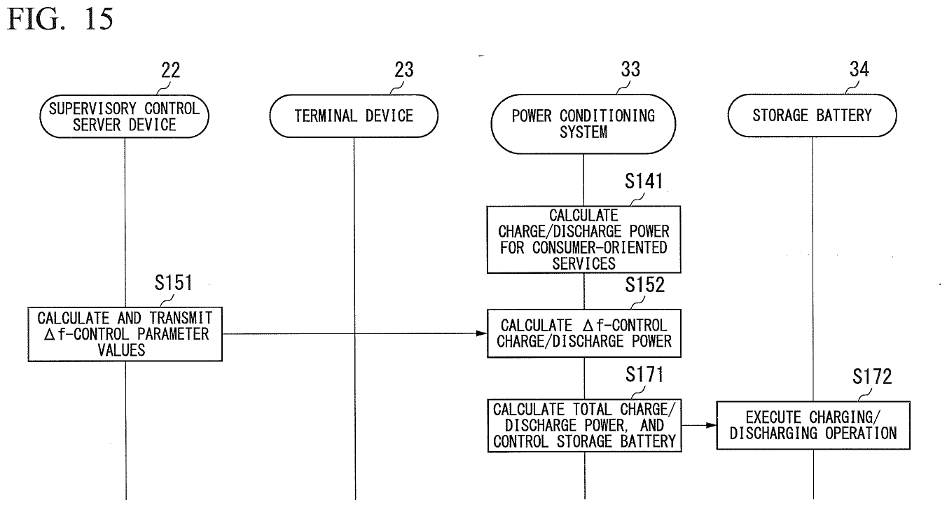

FIG. 15 shows a second example of a process to calculate an amount of charge/discharge power and to control the storage battery 34 (see steps S141, S151, S152, S171, S172). At the timing not to calculate a LFC signal, the terminal device 23, the power conditioning system 33, and the storage battery 34 cooperate together to carry out the process of FIG. 15 instead of the process of FIG. 14 in step S131 of FIG. 13.

Compared with the process of FIG. 14, the process of FIG. 15 precludes steps S161 and S162 relating to a calculation of LFC charge/discharge power. In this case, the power conditioning system 33 calculates total charge/discharge power using the previously-calculated LFC charge/discharge power in step S171. Other steps of FIG. 15 are similar to those shown in FIG. 14.

In this connection, the terminal device 23 may implement the entirety or part of the function of the power conditioning system 33. In the above example, the power conditioning system 33 is configured to transmit or receive information with the terminal device 23. When the terminal device 23 implements the entirety or part of the function of the power conditioning system 33, however, the terminal device 23 is configured to transmit or receive information with the supervisory control server device 22.

For example, the supervisory control server device 22 (serving as a host device configured to monitor a plurality of terminal devices 23) may set a plurality of services for each terminal device 23, the terminal device 23 may include a summation calculation part configured to calculate summation of charge/discharge power calculated for each service according to the upper-limit value of charge/discharge power for each service and a charge/discharge control part configured to control the storage battery 34 to charge or discharge power based on the summation of charge/discharge power calculated by the summation calculation part.

In addition, the terminal device 23 may include an energy-cumulative-value calculation part configured to calculate a cumulative value of electric energy with respect to charging power for each service and discharging power for each service as well as the charging power and the discharging power for the storage battery 34, and a communication part configured to transmit the cumulative value of electric energy calculated by the energy-cumulative-value calculation part to the supervisory control server device 22.

The terminal device 23 may receive a value of charge/discharge power from the supervisory control server device 22 with respect to at least one of multiple services.

As to a service having a value of charge/discharge power received from the supervisory control server device 10, the terminal device 23 may use the received value of charge/discharge power as its calculated value to thereby control the storage battery 34 to charge or discharge power. As to another service having a value of charge/discharge power not received from the supervisory control server device 22, the terminal device 23 may calculate an amount of charge/discharge power by itself (with its charge/discharge power calculation part), calculate summation of the received or calculated value of charge/discharge power by its summation calculation part, and then transmit the calculated summation to the power conditioning system 33 by its communication part, thus controlling the storage battery 34 to charge or discharge power.

When a plurality of services can be classified into consumer-oriented services and system-oriented services, the terminal device 23 may further include a mode switcher configured to switch one mode to carry out consumer-oriented services alone and another mode to carry out consumer-oriented services and system-oriented services.

As described above, the supervisory control server device 22 is configured to transmit a value of charge/discharge power directed to at least one of multiple services but to transmit the upper-limit value of charge/discharge power with respect to remaining services.

As described above, the supervisory control server device 22 is configured to transmit an amount of charge/discharge power or the upper-limit value of charge/discharge power to the terminal device 23 or the power conditioning system 33, and therefore it is possible for the power storage system 32 to carry out concurrent multiuse services using multiple services having different responses in cooperation with other types of power storage systems without making direct communication between the terminal device 23 and the power conditioning system 33.

The supervisory control server device 22 is configured to calculate the upper-limit value of charge/discharge power using at least one of the system status information and the status information of the power storage system 32. Accordingly, the supervisory control server device 22 is able to calculate the upper-limit value of charge/discharge power depending on services.

When the supervisory control server device 22 serves as a host device configured to monitor a plurality of power conditioning systems 33, the summation calculation part 193 shown in FIG. 6 is configured to calculate summation of charge/discharge power calculated for multiple services according to the upper-limit value of charge/discharge power for each power conditioning system 33 and for each of multiple services. The charge/discharge control part 194 controls the storage battery 34 to charge or discharge power based on the summation calculated by the summation calculation part 193.

As described above, the charge/discharge control part 194 controls the storage battery 34 to charge or discharge power according to the upper-limit value of charge/discharge power set for each service and an amount of charge/discharge power which is calculated at an appropriate location (e.g. the supervisory control server device 22, the terminal device 23, or the power conditioning system 33), and therefore it is possible to prevent services, which are concurrently executed during charging/discharging operations implemented by the concurrent execution of multiple services having different characteristics, from being suppressed by other charging/discharging operations implemented by other services. According to the power conditioning system 33, it is possible to carry out a plurality of services having different responses in a concurrent-multiuse manner.

In addition, the charge/discharge control part 194 controls the storage battery 34 to charge or discharge power according to summation of charge/discharge power which is calculated according to the upper-limit value of charge/discharge power set by the supervisory control server device 22, and therefore it is possible for the storage system 32 to carry out a plurality of services having different response in a concurrent-multiuse manner in cooperation with other storage systems without making a direct communication with other storage systems. According to the power conditioning system 33, it is possible for the power storage system 32 to carry out a plurality of services having different responses in cooperation with other power storage systems.

As to the periodicity to switch a charging operation and a discharging operation, the consumer-installed system 31 may combine relatively-short-period services (e.g. services mainly using power in units of kilowatts (kW)) and relatively-long-period services (e.g. services mainly using energy in units of kilowatt hours (kWh)), and therefore it is possible to carry out services in a concurrent-multiuse manner without causing any competition affecting charging rates of the storage battery 34 among those services.

The energy-cumulative-value calculation part 195 is configured to calculate cumulative values of electric energy for each service with respect to charging and discharging for each service as well as charging and discharging of the storage battery 34. That is, the energy-cumulative-value calculation part 195 calculates cumulative values of electric energy with respect to separate cases relating to charging and discharging for each service and charging and discharging of the storage battery 34, and therefore it is possible to finely calculate incentive payments using cumulative values of electric energy.

The power conditioning system 33 receives a value of charge/discharge power relating to at least one of multiple services from the terminal device 23. This may relatively reduce the load of the power conditioning system 33 to calculate an amount of charge/discharge power, and therefore it is possible to secure an adequate response of the consumer-installed system 31. In particular, it is possible to secure an adequate response in the entirety of the consumer-installed system 31 since the terminal device 23 may calculate an amount of charge/discharge power in services not requiring quick response such as LFC services.

In addition, the terminal device 23 may bear part of functions to calculate values of LFC charge/discharge power and values of Δf-control charge/discharge power. This makes it possible to connect the terminal device 23 to the existing power storage system for the use of the LFC and the Δf control. Using the terminal device 23 having the above function, it is possible to effectively utilize the existing power storage system.

In services receiving a value of charge/discharge power, the power conditioning system 33 uses the received value of charge/discharge power as its calculated value of charge/discharge power. In services not receiving a value of charge/discharge power, the power conditioning system 33 calculates a value of charge/discharge power by itself, calculates summation of the received or calculated value of charge/discharge power, and thereby controls charging and discharging with the storage battery 34.

This may reduce the load of the power conditioning system 33 to calculate a value of charge/discharge power, and therefore it is possible to secure an adequate response of the consumer-installed system 31. In particular, it is possible to secure an adequate response in the entirety of the consumer-installed system 31 since the terminal device 23 may calculate a value of charge/discharge power in services not requiring quick response such as LFC services.

When a plurality of services can be classified into consumer-oriented services and system-oriented services, the mode switcher 196 is configured to switch a mode to carry out consumer-oriented services alone and another mode to carry out consumer-oriented services and system-oriented services. Using the mode switcher 196 configured to switch modes, in the mode to carry out consumer-oriented services alone, for example, it is possible to provide services according to consumers' demands without any restrictions as to the upper-limit value of charge/discharge power which is set by the supervisory control server device 22.

In the above, consumer-oriented services refer to any one of or a combination of the peak shifting, the peak cutting, and the BCP (Business Continuous Plan) to retain the SOC of the storage battery 34 at a certain value or more and to thereby charge power in case of disaster while system-oriented services refer to any one of or a combination of the Δf control, the load frequency control (LFC), and the demand response. The present embodiment may exemplify an example of functionality to concurrently implement three services, namely the peak shifting, the LFC, and the Δf control, but it is possible to expand the functionality to implement five services (e.g. the peak shifting, the peak cutting, the BCP, the Δf control, the LFC, etc.). To expand the functionality, it is necessary to calculate a value of charge/discharge power for each service and to thereby control charging and discharging with storage batteries according to summation of charge/discharge power. However, the expanded functionality may have demerits to reduce a PCS output (i.e. power in units of kilowatts (kW)) allocated to each service or to reduce the allocated value of charge/discharge energy (i.e. energy in units of kilowatt hours (kWh)). To compensate for demerits, it is effective to increase the number of consumers with respect to system-oriented services.

As to the periodicity to switch charging and discharging, the consumer-installed system 31 may implement a combination of relatively-short-period services (e.g. services mainly using power in units of kilowatts (kW)) and relatively-long-period services (e.g. services mainly using energy in units of kilowatt hours (kWh)), and therefore it is possible to achieve services in a concurrent-multiuse manner without causing any competition affecting charging rates of the storage battery 34 among those services.

In the above, the terminal device 23 may bear the entirety of or part of functionality of the power conditioning system 33. In this case, it is expected to produce the same effect as the power conditioning system 33 fully implementing its functionality.

In addition, the terminal device 23 may calculate a value of charge/discharge power with respect to at least one of multiple services. This may reduce the load of the power conditioning system 33 to calculate a value of charge/discharge power, and therefore it is possible to secure an adequate response of the consumer-installed system 31. In particular, it is possible to secure an adequate response in the entirety of the consumer-installed system 31 since the terminal device 23 may calculate a value of charge/discharge power in services not requiring quick response such as LFC services.

In addition, the terminal device 23 may bear part of functionality to calculate a value of LFC charge/discharge power and a value of Δf-control charge/discharge power, wherein the terminal device 23 can be connected to the existing power storage system to achieve LFC services and Δf control services. Using the terminal device 23, it is possible to effectively utilize the existing power storage system.

It is possible to use power storage systems (e.g. the power storage system 32) according to the present embodiment in various manners. For example, the present embodiment may effectively work in a power storage system including an electric vehicle (which may serve as a storage battery) and a charger/discharger. To use an electric vehicle in a power storage system, it is necessary for a terminal device to collect the information as to whether or not the electric vehicle is electrically connected to the power system via the electric vehicle or the charger/discharger. When the electric vehicle is electrically connected to the power system, it is expected to realize the same function and performance as the power storage system, and therefore it is possible to apply the aforementioned service(s) to the electric vehicle.

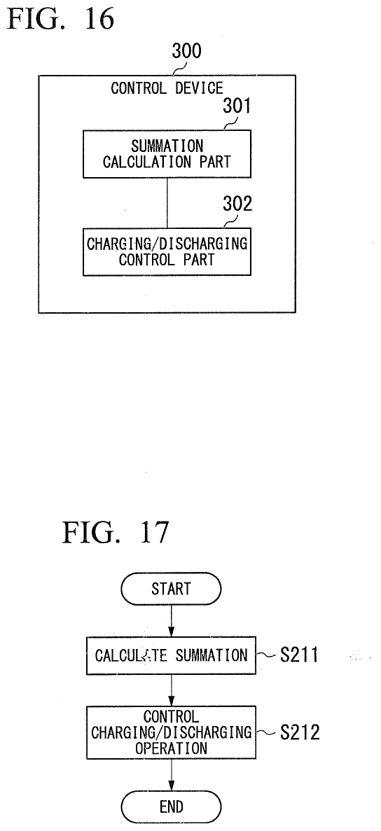

Next, another embodiment of the present invention will be described with reference to FIGS. 16 and 17. FIG. 16 shows a configuration of a control device 300 which includes a summation calculation part 301 and a charge/discharge control part 302. A host device (unillustrated here) is configured to manage a plurality of control devices and to set the upper limit value of charge/discharge power for each control device and for each of multiple services. The summation calculation part 301 is configured to calculate summation of charge/discharge power by adding up values of charge/discharge power calculated for multiple services according to the upper-limit value of charge/discharge power for each service. The charge/discharge control part 302 is configured to control storage batteries to charge or discharge power according to the summation of charge/discharge power calculated by the summation calculation part 301.

As described above, the charge/discharge control part 302 controls a storage battery to charge or discharge power in consideration of a value of charge/discharge power calculated according to the upper-limit value of charge/discharge power for each service, and therefore it is possible to prevent charging and discharging for one service from suppressing charging and discharging for another service. Therefore, the control device 300 can carry out a plurality of services having different responses in a concurrent-multiuse manner.

In addition, the charge/discharge control part 302 controls storage batteries to charge or discharge power in consideration of the summation of charge/discharge power calculated according to the upper-limit value of charge/discharge power set by the host device, and therefore the power storage system including the control device 300 can carry out a plurality of services in a concurrent-multiuse manner in cooperation with other power storage systems without making a direct communication with other power storage systems. Using the control device 300, it is possible for the power storage system to carry out a plurality of services having different responses in a concurrent-multiuse manner in cooperation with other power storage systems.

FIG. 17 shows an example of a process to implement a control method according to another embodiment of the present invention. The control method of FIG. 17 includes step S211 to calculate summation of charge/discharge power and step S212 to control a storage battery to charge or discharge power. As described above, a host device configured to manage a plurality of control devices may set the upper-limit value of charge/discharge power for each control device and for each of multiple services. In step S211, the summation of charge/discharge power is calculated by adding up values of charge/discharge power for multiple services according to the upper-limit value of charge/discharge power for each service. In step S212, a storage battery is controlled to charge or discharge power according to the summation of charge/discharge power produced in step S211.

As described above, the storage battery is controlled to charge or discharge power in consideration of values of charge/discharge power calculated according to the upper-limit value of charge/discharge power set for each service, and therefore it is possible to prevent charging and discharging for one service from suppressing charging and discharging for another service. According to the control method of FIG. 17, it is possible to carry out a plurality of services having different responses in a concurrent-multiuse manner.

In addition, a storage battery is controlled to charge or discharge power in consideration of the summation of charge/discharge power calculated according to the upper-limit value of charge/discharge power set by the host device, the power storage system implementing the process of FIG. 17 can carry out a plurality of services in a concurrent-multiuse manner in cooperation with other power storage systems without making a direct communication with other power storage systems. According to the control method of FIG. 17, it is possible for the power storage system to carry out a plurality of services having different responses in a concurrent-multiuse manner in cooperation with other power storage systems.

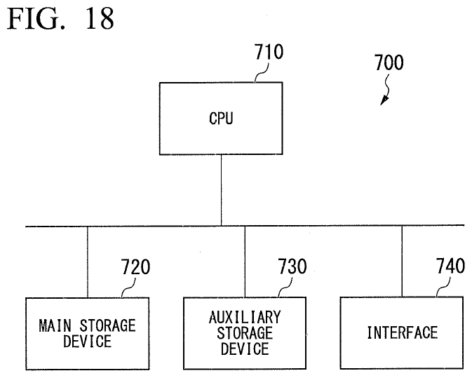

FIG. 18 shows a configuration example of a computer 700 applicable to any devices according to any embodiments. In FIG. 18, the computer 700 includes a CPU 710, a main storage device 720, an auxiliary storage device 730, and an interface 740. The computer 700 can be installed in any one of the supervisory control server device 22, the terminal device 23, the power conditioning system 33, and the control device 300. Herein, the auxiliary storage device 730 is configured to store programs representing the operations of the functional parts configured to carry out the foregoing processes. The CPU 710 reads programs from the auxiliary storage device 730 and expand programs on the main storage device 720 so as to carry out the foregoing processes according to programs. According to programs, the CPU 710 may create storage areas corresponding to the foregoing storages on the main storage device 720 according to programs.

The interface 740 has a communication function to carry out communications between the foregoing devices (e.g. the supervisory control server device 22, the terminal device 23, the power conditioning device 33, and the control device 300) and other devices under the control of the CPU 710. The interface 740 may be equipped with a display device configured to display data activating user interfaces of the foregoing devices (e.g. the supervisory control server device 22, the terminal device 23, the power conditioning system 33, and the control device 300) and an input device configured to input data.

When the computer 700 is installed in the power conditioning system 33, the auxiliary storage device 730 may store programs representing the operations of the controller 190 and its related parts shown in FIG. 6. The CPU 710 reads programs from the auxiliary storage device 730 and expands programs on the main storage device 720 so as to carry out the foregoing processes according to programs. In addition, the CPU 710 may create a storage area corresponding to the storage 180 on the main storage device 720 according to programs. The interface 740 has a communication function by which the communication part 110 may carry out a communication under the control of the CPU 710.

When the computer 700 is installed in the control device 300 shown in FIG. 16, the auxiliary storage device 730 stores programs representing the operations of the summation calculation part 301 and the charge/discharge control part 302. The CPU 710 reads programs from the auxiliary storage device 730 and expands programs on the main storage device 720 so as to carry out the foregoing processes according to programs.

In this connection, it is possible to store programs achieving the entirety or part of processing carried out by any one of the foregoing devices (e.g. the supervisory control server device 22, the terminal device 23, the power conditioning system 33, and the control device 300) on computer-readable storage media, and therefore a computer system may load and execute programs stored on storage media to thereby achieve the foregoing processes. Herein, the term “computer system” may include software such as an operating system (OS) and hardware such as peripheral devices. In addition, the term “computer-readable storage media” may include flexible disks, magneto-optical disks, ROM (Read-Only Memory), portable media such as CD-ROM, storage devices such as hard disks embedded in computer systems, and the like. The foregoing programs may achieve part of the foregoing functions, or the foregoing programs may be combined with preinstalled programs of computer systems to achieve the foregoing functions.

Heretofore, the foregoing embodiments have been described with respect to control methods how to charge or discharge power with storage batteries at consumer sides in connection with power-interconnect lines of power systems using power generation facilities. However, the present invention can be applied to any types of systems and machines using storage batteries such as automobiles, airplanes, communication systems, and information processing systems.

Lastly, the present invention is not necessarily limited to the foregoing embodiments, which can be modified in various manners, since the concrete examples are not necessarily limited to the foregoing embodiments. The present invention may embrace any design changes and modifications within the scope of the invention as defined in the appended claims.

### (Supplementary Notes)

The present invention can be embodied in various ways according to (1) through (18) as follows.

(1) A host device is configured to manage a power storage system including a storage battery in connection with a plurality of services. The host device is further configured to transmit a value of charge/discharge power for at least one service to the power storage system while transmitting an upper-limit value of charge/discharge power for another service to the power storage system.
(2) The host device may calculate the upper-limit value of charge/discharge power using at least one of the system status information of a power system and the status information of the power storage system.
(3) A control device is configured to control a power storage system including a storage battery in connection with a host device configured to set an upper-limit value of charge/discharge power for each service among a plurality of services. The control device may include a summation calculation part configured to calculate a value of charge/discharge power for each service so as to produce a summation of charge/discharge power for a plurality of services according to the upper-limit value of charge/discharge power for each service, and a charge/discharge control part configured to control the storage battery to charge or discharge power according to the summation of charge/discharge power.
(4) The control device further includes an energy-cumulative-value calculation part configured to calculate a cumulative value of electric energy for each service, for each of charging power and discharging power for each service, and for each of charging power and discharging power of the storage battery, and a communication part configured to transmit the cumulative value of electric energy to a host device or a terminal device.
(5) The control device may receive a value of charge/discharge power for at least one service among the plurality of services from a terminal device.
(6) The control device may use the received value of charge/discharge power as the calculated value of charge/discharge power in a service providing the received value of charge/discharge power among a plurality of services. In another service not providing the received value of charge/discharge power among the plurality of services, the control device may calculate the value of charge/discharge power by itself so as to produce the summation of charge/discharge power by adding up the received value or the calculated value of charge/discharge power, thus controlling the storage battery to charge or discharge power.
(7) The control device further includes a mode switcher when a plurality of services are classified into a consumer-oriented service and a system-oriented service. The mode switcher is configured to switch a first mode to carry out the consumer-oriented service alone and a second mode to carry out the consumer-oriented service and the system-oriented service.
(8) In the above, the consumer-oriented service is peak shifting or peak cutting while the system-oriented service is any one of a Δf control (where Δf denotes a frequency deviation between system frequency and reference frequency), a load frequency control (LFC), and a demand response or its combination.
(9) A terminal device is configured to control a power storage system including a storage battery in connection with a host device configured to set an upper-limit value of charge/discharge power for each service among a plurality of services. The terminal device includes a summation calculation part configured to calculate a value of charge/discharge power for each service so as to produce a summation of charge/discharge power for a plurality of services according to the upper-limit value of charge/discharge power for each service, and a charge/discharge control part configured to control the storage battery to charge or discharge power according to the summation of charge/discharge power.
(10) The terminal device further includes an energy-cumulative-value calculation part configured to calculate a cumulative value of electric energy for each service, for each of charging power and discharging power for each service, and for each of charging power and discharging power of the storage battery, and a communication part configured to transmit the cumulative value of electric energy to a host device.
(11) The terminal device may receive a value of charge/discharge power for at least one service among the plurality of services from a host device.
(12) The terminal device may use the received value of charge/discharge power as the calculated value of charge/discharge power in a service providing the received value of charge/discharge power among a plurality of services. In another service not providing the received value of charge/discharge power among a plurality of services, the terminal device may calculate the value of charge/discharge power by itself so as to produce the summation of charge/discharge power by adding up the received value or the calculated value of charge/discharge power, thus controlling the storage battery to charge or discharge power.
(13) The terminal device further includes a mode switcher when a plurality of services are classified into a consumer-oriented service and a system-oriented service. The mode switcher is configured to switch a first mode to carry out the consumer-oriented service alone and a second mode to carry out the consumer-oriented service and the system-oriented service.
(14) The terminal device may calculate the value of charge/discharge power for at least one service among a plurality of services so as to transmit the calculated value of charge/discharge power to a control device configured to control the storage battery in the power storage system.
(15) A charge/discharge control system includes a terminal device and a control device configured to control a storage battery with respect to a plurality of services. The terminal device is configured to calculate a value of charge/discharge power for at least one service among a plurality of services. The control device is configured to calculate a summation of charge/discharge power for a plurality of services according to an upper-limit value of charge/discharge power for each service and to thereby control the storage battery to charge or discharge power according to the summation of charge/discharge power.
(16) A storage-batteries supervisory control system includes a host device and a charge/discharge control system further including a terminal device and a control device configured to control a storage battery with respect to a plurality of services. The host device is configured to set an upper-limit value of charge/discharge power for each service. The terminal device is configured to calculate a value of charge/discharge power for at least one service among a plurality of services. The control device is configured to calculate a summation of charge/discharge power for a plurality of services according to the upper-limit value of charge/discharge power for each service and to thereby control the storage battery to charge or discharge power according to the summation of charge/discharge power.
(17) A control method for controlling a storage battery with respect to a plurality of services includes the steps of: calculating a value of charge/discharge power for each service among the plurality of services; calculating a summation of charge/discharge power for a plurality of services according to an upper-limit value of charge/discharge power for each service; and controlling the storage battery to charge or discharge power according to the summation of charge/discharge power.
(18) A computer-readable storage medium is provided to store a program causing a computer to control a storage battery with respect to a plurality of services by implementing the steps of: calculating a value of charge/discharge power for each service among a plurality of services; calculating a summation of charge/discharge power for a plurality of services according to an upper-limit value of charge/discharge power for each service; and controlling the storage battery to charge or discharge power according to the summation of charge/discharge power.

What is claimed is:

1. A control device configured to control a power storage system including a storage battery in connection with a host device configured to set an upper-limit value of charge/discharge power for each service among a plurality of services, comprising:
a summation calculation part configured to calculate a value of charge/discharge power for each service so as to produce a summation of charge/discharge power for the plurality of services according to the upper-limit value of charge/discharge power for each service; and
a charge/discharge control part configured to control the storage battery to charge or discharge power according to the summation of charge/discharge power.

2. The control device according to claim 1, further comprising:
an energy-cumulative-value calculation part configured to calculate a cumulative value of electric energy for each service, for each of charging power and discharging power for each service, and for each of charging power and discharging power of the storage battery; and
a communication part configured to transmit the cumulative value of electric energy to a host device or a terminal device.

3. The control device according to claim 1, wherein in a service providing a received value of charge/discharge power among the plurality of services, the received value of charge/discharge power is used as the calculated value of charge/discharge power, while in another service not providing the received value of charge/discharge power among the plurality of services, the control device calculates the value of charge/discharge power by itself so as to produce the summation of charge/discharge power by adding up the received value or the calculated value of charge/discharge power, thus controlling the storage battery to charge or discharge power.

4. The control device according to claim 1, further comprising a mode switcher when the plurality of services are classified into a consumer-oriented service and a system-oriented service, wherein the mode switcher is configured to switch a first mode to carry out the consumer-oriented service alone and a second mode to carry out the consumer-oriented service and the system-oriented service.

5. The control device according to claim 4, wherein the consumer-oriented service is peak shifting or peak cutting while the system-oriented service is any one of a Δf control (where Δf denotes a frequency deviation between system frequency and reference frequency), a load frequency control (LFC), and a demand response or its combination.

6. A terminal device configured to control a power storage system including a storage battery in connection with a host device configured to set an upper-limit value of charge/discharge power for each service among a plurality of services, comprising:
a summation calculation part configured to calculate a value of charge/discharge power for each service so as to produce a summation of charge/discharge power for the plurality of services according to the upper-limit value of charge/discharge power for each service; and
a charge/discharge control part configured to control the storage battery to charge or discharge power according to the summation of charge/discharge power.

7. The terminal device according to claim 6, further comprising:
an energy-cumulative-value calculation part configured to calculate a cumulative value of electric energy for each service, for each of charging power and discharging power for each service, and for each of charging power and discharging power of the storage battery; and
a communication part configured to transmit the cumulative value of electric energy to a host device.

8. The terminal device according to claim 6, wherein in a service providing a received value of charge/discharge power among the plurality of services, the received value of charge/discharge power is used as the calculated value of charge/discharge power, while in another service not providing the received value of charge/discharge power among the plurality of services, the terminal device calculates the value of charge/discharge power by itself so as to produce the summation of charge/discharge power by adding up the received value or the calculated value of charge/discharge power, thus controlling the storage battery to charge or discharge power.

9. The terminal device according to claim 6, further comprising a mode switcher when the plurality of services are classified into a consumer-oriented service and a system-oriented service, wherein the mode switcher is configured to switch a first mode to carry out the consumer-oriented service alone and a second mode to carry out the consumer-oriented service and the system-oriented service.

10. A control method for controlling a storage battery with respect to a plurality of services, comprising:
calculating a value of charge/discharge power for each service among the plurality of services;
calculating a summation of charge/discharge power for the plurality of services according to an upper-limit value of charge/discharge power for each service; and
controlling the storage battery to charge or discharge power according to the summation of charge/discharge power.
